(19) United States
(12) Patent Application Publication
(10) Pub. No.: US 2025/0135626 A1
(43) Pub. Date: May 1, 2025

(54) MAGNETIC DRILL PRESS

(71) Applicant: MAKITA CORPORATION, Anjo-shi (JP)

(72) Inventors: Jun UEDA, Anjo-shi (JP); Shizuki Okajima, Anjo-shi (JP); Hidenori Nagasaka, Anjo-shi (JP); Yuta Araki, Anjo-shi (JP); Tomohiko Imae, Anjo-shi (JP); Ryohei Hotta, Anjo-shi (JP); Kodai Sakagawa, Anjo-shi (JP)

(73) Assignee: MAKITA CORPORATION, Anjo-shi (JP)

(21) Appl. No.: 18/889,826

(22) Filed: Sep. 19, 2024

(30) Foreign Application Priority Data
Oct. 27, 2023 (JP) 2023-184965
Oct. 27, 2023 (JP) 2023-184966
Oct. 31, 2023 (JP) 2023-186690

(51) Int. Cl. B25H 1/00; B23B 43/00

(52) U.S. Cl. CPC B25H 1/0071; B23B 43/00

(57) ABSTRACT

A magnetic drill press includes a magnetic base, a main body portion coupled to the magnetic base, a drill unit including a spindle and supported by the main body portion to be movable in a direction parallel to a rotation axis of the spindle, a battery attachment portion configured to detachably hold a battery, and a cover configured to at least partially cover the battery attachment portion. The battery attachment portion includes a rail extending in a straight line in a first direction and configured to slidingly engage with a groove of the battery, and a terminal portion including a terminal configured to be electrically connected with a terminal of the battery. The cover is displaceable relative to the main body portion, and configured to overlap an entirety of the terminal portion, when the cover is at a first position and viewed from a first side in the first direction.

### CROSS-REFERENCE TO RELATED APPLICATION

The present application claims priority to Japanese patent applications No. 2023-184965 filed on Oct. 27, 2023, No. 2023-184966 filed on Oct. 27, 2023 and No. 2023-186690 filed on Oct. 31, 2023. The contents of the foregoing applications are hereby incorporated by reference in their entirety.

### TECHNICAL FIELD

The present disclosure relates to a magnetic drill press.

### BACKGROUND

A magnetic drill press is a device (apparatus) that is configured to be fixed by a magnetic force to a workpiece formed of a magnetic material, and make a hole in the workpiece, using a tool accessory attached to an electric drill, while moving an electric drill supported by a main body portion relative to the workpiece.

For example, JP 2020-157471 A discloses a magnetic drill press that operates using a battery as a power source. Further, J P 2011-104678 A discloses a magnetic drill press capable of supplying a cutting fluid stored in a tank to a tool accessory, in order to inhibit sticking of the tool accessory and the like.

### SUMMARY

There is room for improvement of the above-described magnetic drill presses. One non-limiting object of the present disclosure is to provide improvement relating to a magnetic drill press.

A non-limiting aspect of the present disclosure herein provides a magnetic drill press that includes a magnetic base, a main body portion, a drill unit, a battery attachment portion, and a cover. The magnetic base is configured to be selectively fixed (attached, latched) to a workpiece by a magnetic force. The main body portion is coupled to the magnetic base. The drill unit includes a spindle that is configured to detachably hold a tool accessory (also referred to as a bit). The drill unit is supported by the main body portion to be movable in an axial direction with respect to a rotation axis of the spindle. In other words, the drill unit is supported by the main body portion to be movable in a direction parallel to the rotation axis of the spindle. The battery attachment portion is configured to detachably hold or receive a battery for supplying power to the magnetic drill press. Note that the battery attachment portion may be provided at the main body portion, or may be provided at the drill unit. The cover is configured to at least partially cover the battery attachment portion.

The battery attachment portion includes a rail and a terminal portion. The rail extends in a straight line in a first direction. The rail is configured to slidingly engage with a groove of the battery when the battery is moved from a first side to a second side in the first direction relative to the rail. The terminal portion includes a terminal that is configured to be electrically connected with a terminal of the battery when the battery is disposed at a predetermined position of the battery attachment portion. The cover is displaceable relative to the main body portion, and is configured to overlap an entirety of the terminal portion, when the cover is at a first position and viewed from the first side in the first direction. In other words, when the cover at the first position is projected from the first side in the first direction, the entirety of the terminal portion is included within a projection region of the cover.

According to the present aspect, the cover disposed at the first position can reduce a possibility that chips enter into the battery attachment portion from the first side in the first direction and adhere to the terminal portion. Further, the cover disposed at the first position can reduce a possibility that any kind of impact is applied to the terminal portion from the first side in the first direction and damages the terminal portion. Note that, the cover may be configured to overlap the entirety of the battery attachment portion when the cover is at the first position and viewed from the first side in the first direction.

Another non-limiting aspect of the present disclosure also provides a magnetic drill press that includes a magnetic base, a battery housing portion, a guide portion, a guided portion, a motor, a drill unit, and a cover. The magnetic base is configured to be selectively fixed to a workpiece by a magnetic force. The battery housing portion is coupled to an upper side of the magnetic base. The battery housing portion has an opening in an upper portion thereof. The guide portion is coupled to the battery housing portion. The guided portion is guided in an up-down direction by the guide portion. The motor is coupled to the guided portion, and configured to be rotated by power supplied from the battery housing portion. The drill unit includes a spindle that is configured to be rotated by the motor. The cover is configured to cover the opening of the battery housing portion.

According to the present aspect, the cover can cover the opening in the upper portion of the battery housing portion. Therefore, the cover can reduce a possibility of chips entering into the battery housing portion from an outside of the battery housing portion. Further, the cover can protect the battery.

### BRIEF DESCRIPTION OF THE DRAWINGS

FIG. 1 is a perspective view of a magnetic drill press according to a first embodiment, when a cover is at a closed position.

FIG. 2 is another perspective view of the magnetic drill press when the cover is at the closed position.

FIG. 3 is a cross-sectional view of the magnetic drill press when the cover is at the closed position.

FIG. 4 is a cross-sectional view along a line IV-IV shown in FIG. 3.

FIG. 5 is a top view of the magnetic drill press.

FIG. 6 is a perspective view of the magnetic drill press when the cover is at an open position.

FIG. 7 is a cross-sectional view of the magnetic drill press when the cover is at the open position.

FIG. 8 is a partial perspective view of a magnetic drill press according to a second embodiment.

FIG. 9 is a perspective view of an outlet nozzle.

FIG. 10 is a cross-sectional view for describing a coupling structure of an air outlet and the outlet nozzle.

FIG. 11 is a perspective view of a magnetic drill press according to a third embodiment.

FIG. 12 is another perspective view of the magnetic drill press.

FIG. 13 is a left-side view of the magnetic drill press.

FIG. 14 is a cross-sectional view of the magnetic drill press.

FIG. 15 is a perspective view of a magnetic drill press according to a fourth embodiment.

FIG. 16 is a perspective view of a magnetic drill press according to a fifth embodiment.

FIG. 17 is an overall perspective view of the magnetic drill press according to the fifth embodiment.

FIG. 18 is a schematic view showing a configuration for switching a permanent magnet between a maximum state and a minimum state.

FIG. 19 is a schematic view showing an arrangement of magnets in each of the maximum state and the minimum state.

FIG. 20 is an overall perspective view of a magnetic drill press according to a sixth embodiment, in which a drill unit and a main housing are in a non-tilted state.

FIG. 21 is an overall perspective view of the magnetic drill press according to the sixth embodiment, in which the drill unit and the main housing are in a tilted state.

FIG. 22 is an overall perspective view of a magnetic drill press according to a seventh embodiment.

FIG. 23 is an overall perspective view of the magnetic drill press according to the seventh embodiment.

FIG. 24 is an overall perspective view of a magnetic drill press according to an eighth embodiment.

FIG. 25 is an overall exploded perspective view of the magnetic drill press according to the eighth embodiment.

FIG. 26 is a partial cross-sectional view showing an arrangement of a cam and protruding members, with the protruding members at a retracted position.

FIG. 27 is a partial cross-sectional view showing an arrangement of the cam and the protruding members, with the protruding members at a protruding position.

FIG. 28 is an overall left side view showing a usage state of the magnetic drill press according to the eighth embodiment, with the protruding members at the protruding position.

FIG. 29 is an overall perspective view of a magnetic drill press according to a ninth embodiment.

FIG. 30 is an overall perspective view of a magnetic drill press according to a tenth embodiment.

FIG. 31 is an overall perspective view of the magnetic drill press according to the tenth embodiment.

### DETAILED DESCRIPTION OF THE EMBODIMENTS

Hereinafter, representative and non-limiting embodiments according to the present disclosure will be described in detail with reference to the drawings. This detailed description is simply intended to show, to a person skilled in the art, details for embodying preferable examples of the present disclosure, and is not intended to limit the scope of the present disclosure. Further, additional features and the disclosure presented below can be used separately or together with other features and disclosures, in order to provide a further improved device, and a manufacturing method and a usage method thereof.

Further, combinations of features and processes disclosed in the following detailed description are not essential, in broad terms, when embodying the present disclosure, and, in particular, are given for describing representative specific examples of the present disclosure. Furthermore, when presenting additional and effective embodiments of the present disclosure, various features of representative specific examples described above and below, and various features described in independent and dependent claims need not necessarily be combined as in the specific examples given here, or in a given order.

All features listed in the present disclosure and/or in the scope of the claims are intended to be disclosed separately, and independently of each other, as limitations to the disclosure at the time of filing and to the claimed specific items, separately to the configuration of features listed in the embodiments and/or in the scope of the claims. Furthermore, description relating to all numerical ranges and groups or collections are treated as intending to disclose configurations related thereto, as limitations to the disclosure at the time of filing and to the claimed specific items.

In a non-limiting embodiment of the present disclosure, the cover may be configured to substantially cover an entirety of an exposed portion of a battery attached to a battery attachment portion that is exposed from the battery attachment portion when a cover is at a first position. According to this embodiment, the cover disposed at the first position can protect the battery and the terminal portion from impact from various directions.

In addition to, or in the alternative to the preceding embodiment, the battery attachment portion may include a recess that is configured for at least a portion of the battery to be fitted therein. The recess may have an opening on the first side in the first direction. The cover may be configured to substantially block the opening of the recess when the cover is at the first position. According to this embodiment, when the cover is at the first position, the cover and a wall portion or wall portions defining the recess can substantially cover the entirety of the battery. It is thus possible to reliably reduce a possibility of chips entering into the battery attachment portion. Further, the cover and the wall portion(s) defining the recess can protect the battery and the terminal portion from impact from various directions.

In addition to, or in the alternative to the preceding embodiments, the recess may be configured to accommodate at least a half of the battery. According to this embodiment, the battery can be more effectively protected from impact.

In addition to, or in the alternative to the preceding embodiments, the magnetic drill press may further include a locking member configured to lock the cover at the first position relative to a main body portion. According to this embodiment, the cover can reduce a possibility of the battery falling when the magnetic drill press is in a posture in which the first side thereof is oriented in a gravity direction.

In addition to, or in the alternative to the preceding embodiments, the cover may be coupled to the main body portion to be pivotable (rotatable) between the first position and a second position. The cover may be configured to allow attachment and removal of the battery when the cover is at the second position. According to this embodiment, a cover having excellent operability is realized.

In addition to, or in the alternative to the preceding embodiments, the first direction may be an axial direction in relation to a rotation axis of a spindle (in other words, the direction parallel to the rotation axis of the spindle). According to this embodiment, the attachment and removal of the battery is facilitated when the magnetic drill press is in a posture in which the rotation axis of the spindle extends in a vertical direction, even if there is a wall or walls surrounding the magnetic drill press.

### First Embodiment

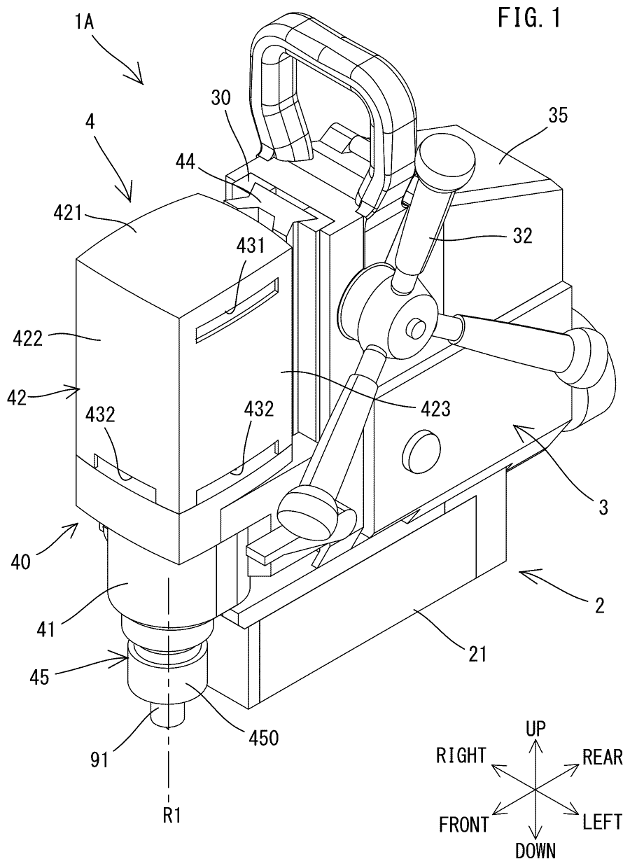

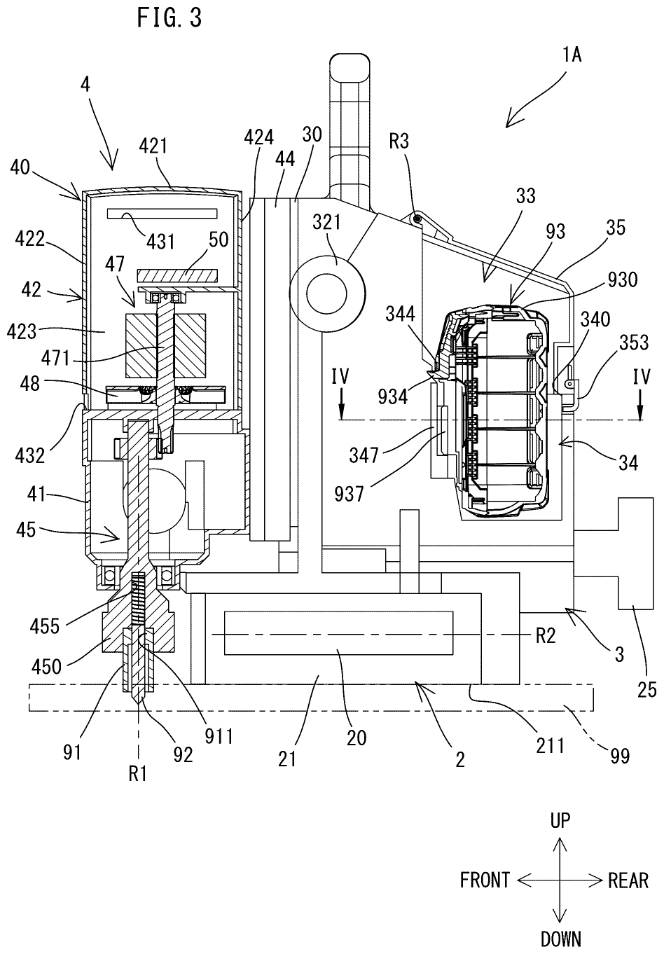

A magnetic drill press 1A according to a first exemplary embodiment is described with reference to FIG. 1 to FIG. 7. The magnetic drill press 1A is a portable power tool. More specifically, the magnetic drill press 1A is a power tool configured to form a hole in a workpiece 99, using an electric drill, while the magnetic drill press 1A is fixed by a magnetic force (magnetically latched) to the workpiece 99 (shown in FIG. 3 only) formed of a magnetic material (iron, for example). Note that the magnetic drill press 1A may also be referred to as a magnetic drill and a magnetic drilling machine.

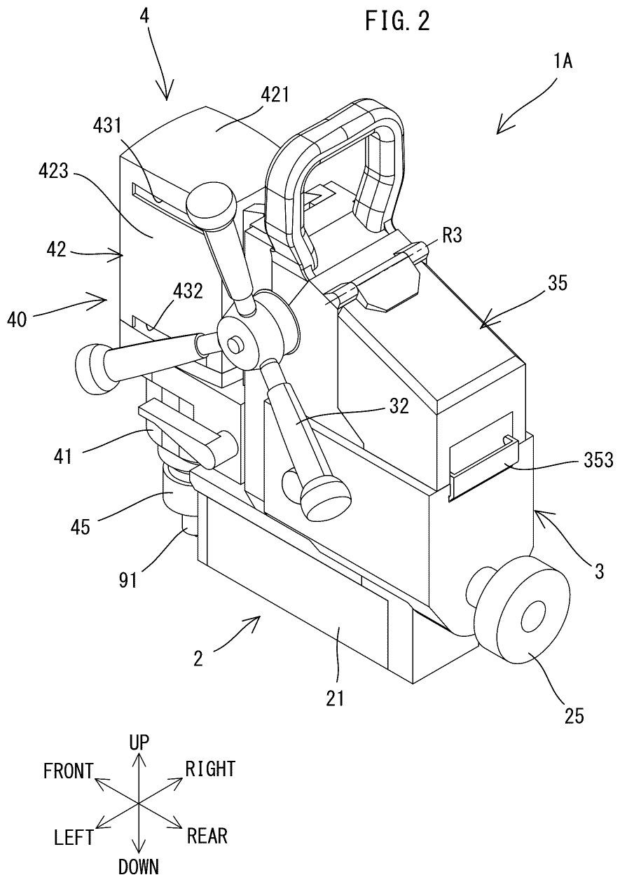

First, an overall configuration of the magnetic drill press 1A will be described. As shown in FIG. 1 and FIG. 2, the magnetic drill press 1A includes a magnetic base 2 configured to be selectively fixed to the workpiece 99 by a magnetic force, a main body portion 3 coupled to the magnetic base 2, and a drill unit 4 supported by the main body portion 3. The drill unit 4 includes a spindle (also referred to as a drill) 45 configured to detachably hold a tool accessory 91 (an annular cutter, a twist drill bit, for example). The drill unit 4 is supported by the main body portion 3 so as to be movable relative to the main body portion 3, in an axial direction of a rotation axis R1 (i.e., a direction substantially parallel to the rotation axis R1) of the spindle 45. The drill unit 4 moves in response to a manual operation, by a user, of a handle 32 provided on the main body portion 3. While the drill unit 4 is moved in a direction approaching the workpiece 99, the hole is formed in the workpiece 99 by the tool accessory 91 that rotates together with the spindle 45.

Hereinafter, a detailed configuration of the magnetic drill press 1A is described.

First, the magnetic base 2 is described. As shown in FIG. 3, the magnetic base 2 includes a holder 21 and a magnet 20. The holder 21 has a contact surface 211 that is configured to come into contact with the workpiece 99. The magnet 20 is supported by the holder 21. In the present embodiment, a permanent magnet is employed as the magnet 20. The magnet 20 is supported so as to be rotatable around a rotation axis R2 relative to the holder 21. The rotation axis R2 extends in a direction that is substantially orthogonal to the rotation axis R1 of the spindle 45. Although a detailed illustration and description thereof is omitted here, since this is known technology, the magnetic force acting on the workpiece 99 changes in accordance with a change in the position of the magnet 20 around the rotation axis R2. When the magnet 20 is disposed at a predetermined position around the rotation axis R2, the workpiece 99 is attracted to and fixed to the contact surface 211 by the magnetic force generated by the magnet 20.

In the following description, for the sake of convenience, the extending direction of the rotation axis R1 of the spindle 45 is defined as an up-down direction of the magnetic drill press 1A. In the up-down direction, the side on which the contact surface 211 is positioned is defined as a lower side, and the opposite side is defined as an upper side of the magnetic drill press 1A. Further, the extending direction of the rotation axis R2 of the magnet 20 is defined as a front-rear direction of the magnetic drill press 1A. In the front-rear direction, the side on which the spindle 45 is positioned relative to the magnetic base 2 is defined as a front side, and the opposite side is defined as a rear side of the magnetic drill press 1A. Further, a direction orthogonal to the rotation axis R1 of the spindle 45 and the rotation axis R2 of the magnet 20 is defined as a left-right direction of the magnetic drill press 1A.

Next, the main body portion 3 is described. As shown in FIG. 1 to FIG. 3, the main body portion 3 is coupled to the magnetic base 2, on the opposite side from the contact surface 211 in the up-down direction of the magnetic drill press 1A. In other words, the main body portion 3 is disposed on the upper side of the magnetic base 2. The main body portion 3 is a support body supporting the drill unit 4, and may also be referred to as a drill stand, a main housing, and the like.

A manipulation member 25 for rotating the magnet 20 is disposed at a lower rear end portion of the main body portion 3. In the present embodiment, the manipulation member 25 is a knob that is rotatable around an axis parallel to the rotation axis R2, and is operably coupled to the magnet 20. By manually operating the manipulation member 25 (specifically, rotating the knob), the user can rotate the magnet 20 around the rotation axis R2 to change the strength of the magnetic force acting on the workpiece 99, namely, can change how firmly the magnetic base 2 can be fixed to the workpiece 99. Note that the manipulation member 25 for rotating the magnet 20 may also be embodied as a sliding lever, for example. Further, the manipulation member 25 may be provided at the magnetic base 2 and not at the main body portion 3.

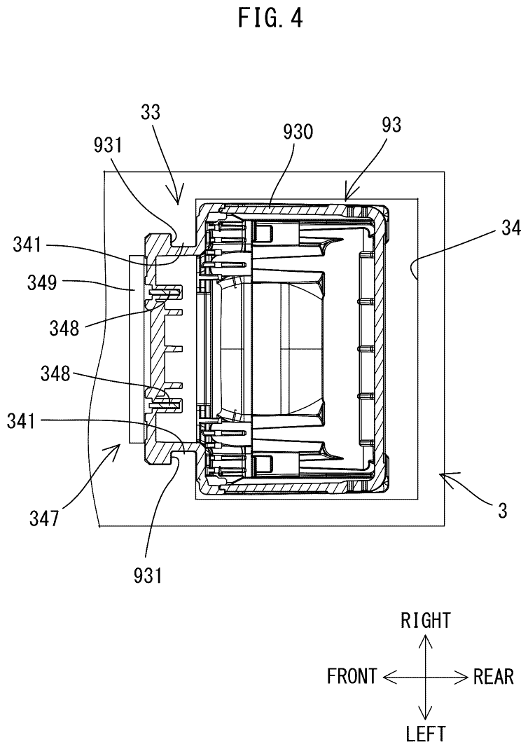

As shown in FIG. 3 and FIG. 4, the main body portion 3 includes a battery attachment portion 33 configured to detachably receive a battery 93. The battery 93 is a rechargeable battery having a known configuration, and includes a substantially cuboid case 930 incorporating battery cells. A first surface having a maximum surface area of the six surfaces of the case 930 is provided with a locking member 934 that is movable between a protruding position and a retracted position, and a terminal portion 937 that includes terminals. A second and third surfaces of the six surfaces that are different from the first surface and that face each other each have grooves 931 that extend in a straight line in a lengthwise direction of the battery 93. Note that the length, width, height of the battery 93, and the arrangement of the locking member 934, the terminal portion 937, and the grooves 931 can be set as desired. Thus, for example, the above-described locking member 934 and terminal portion 937 may be disposed at a surface having a minimum surface area, or may be disposed at a surface having an intermediate surface area between the maximum surface area and the minimum surface area. The configuration of the battery attachment portion 33 that receives the battery 93 will be described in detail later.

Hereinafter, a coupling structure of the main body portion 3 and the drill unit 4 is described. As shown in FIG. 1 and FIG. 3, the drill unit 4 is coupled to the main body portion 3 so as to be movable in the up-down direction relative to the main body portion 3. More specifically, the main body portion 3 and the drill unit 4 are coupled via a rail 30 provided at the main body portion 3, and a rack 44 provided at the drill unit 4.

The rail 30 is disposed at a front end of the main body portion 3, and extends in a straight line in the up-down direction. The rack 44 is shaped like a rod extending in the up-down direction. The rack 44 is disposed at a rear end of the drill unit 4 (more specifically, is fixed to the rear end of a housing 40 to be described later), and is engaged with the rail 30 so as to be slidable in the up-down direction. Although not shown in detail, teeth of the rack 44 are formed at a rear surface of the rack 44. The rack 44 is engaged with a pinion 321. The pinion 321 is operably coupled to the handle 32 that can be manually operated by the user. When the pinion 321 is rotated in response to the manual operation of the handle 32, the drill unit 4 that includes the rack 44 is moved in a straight line in the up-down direction relative to the main body portion 3.

In this way, in the present embodiment, the rack 44 and the pinion 321 configure a movement mechanism (feed mechanism) of the drill unit 4 relative to the main body portion 3. Further, the rack 44 configures a part of a coupling structure that couples the drill unit 4 and the main body portion 3 so as to be movable relative to each other in the up-down direction. However, the coupling structure and the movement mechanism of the drill unit 4 and the main body portion 3 are not limited to this example, and any known coupling structure or movement mechanism may be employed. For example, a feed screw mechanism that includes a feed screw shaft and a nut may be employed as the movement mechanism of the drill unit 4. Further, for example, the coupling structure and the movement mechanism may be separately provided.

Hereinafter, the drill unit 4 is described in detail. As shown in FIG. 1 and FIG. 3, the drill unit 4 according to the present embodiment includes the housing 40, the spindle 45, a motor 47, a fan 48, and a controller 50.

The housing 40 has a hollow box shape. In the present embodiment, the spindle 45, the motor 47, the fan 48, and the controller 50 are accommodated in the housing 40. More specifically, the spindle 45 is housed in a lower half of the housing 40. The motor 47, the fan 48, and the controller 50 are housed in an upper half of the housing 40. Thus, in the following description, the lower half of the housing 40 will also be referred to as a spindle housing portion 41, and the upper half of the housing 40 will also be referred to as a motor housing portion 42. Note that, since a lubricant is disposed within the spindle housing portion 41, the spindle housing portion 41 and the motor housing portion 42 are divided by a partition wall.

The motor housing portion 42 has a generally rectangular box shape, and includes an upper wall portion 421, a front wall portion 422, left and right side wall portions 423, and a rear wall portion 424. Air inlets 431 for introducing air into the housing 40 are provided at an upper end portion of the motor housing portion 42. More specifically, the air inlets 431 are provided at each of upper end portions of the side wall portions 423 (namely, at two locations in total). Air outlets 432 for discharging the air from the housing 40 are provided at a lower end portion of the motor housing portion 42. More specifically, the air outlets 432 are provided at each of lower end portions of the front wall portion 422 and the side wall portions 423 (namely, at three locations in total).

The spindle 45 is supported so as to be rotatable around the rotation axis R1 relative to the housing 40. A lower end portion of the spindle 45 protrudes downward from a lower end of the housing 40 (the spindle housing portion 41). The lower end portion of the spindle 45 includes a tool attachment portion 450 configured to detachably hold the tool accessory 91. Note that the tool attachment portion 450 may also be referred to as a chuck, an arbor, and the like. The tool attachment portion 450 holds the tool accessory 91 such that a central axis of the tool accessory 91 coincides with the rotation axis R1.

The spindle 45 has an insertion hole 455 that extends upward in a straight line along the rotation axis R1, from a lower end of the spindle 45. The insertion hole 455 is configured to receive a pilot pin 92. The pilot pin 92 is a known component used to position the rotation axis R1 of the spindle 45, and thus the center of a hole to be formed in the workpiece 99 by the tool accessory, at a desired point on the workpiece 99. The pilot pin 92 is inserted into a through hole 911 of the tool accessory 91 and is held, and can move in a straight line along the central axis of the tool accessory 91.

Although not shown in detail, since it is a known configuration, a container storing a cutting fluid can be selectively attached to the magnetic drill press 1A. A flow path for supplying the cutting fluid to the tool accessory 91 is provided in the interior of the spindle 45. When the pilot pin 92 is pressed against the workpiece 99 and moves upward, the flow path is opened, and the cutting fluid passes through the flow path and is supplied to the tool accessory 91.

The motor 47 is operably coupled to the spindle 45, and is configured to drive the spindle 45 to rotate. In the present embodiment, an output shaft 471 of the motor 47 extends in parallel to the spindle 45. A lower end portion of the output shaft 471 protrudes into the spindle housing portion 41, and a drive gear is formed on this section. The drive gear is engaged with a driven gear fixed to an upper end portion of the spindle 45. The drive gear and the driven gear configure a gear train for speed reduction.

The fan 48 is fixed to the output shaft 471 below a stator of the motor 47, and rotates integrally with the output shaft 471. The fan 48 is positioned inside the lower end portion of the motor housing portion 42, and the above-described air outlets 432 are disposed radially outward of the fan 48. When the fan 48 rotates in accordance with the driving of the motor 47, an air flow is generated. The air flows into the motor housing portion 42 through the air inlets 431 and flows out from the motor housing portion 42 through the air outlets 432. The air that has flowed in from the air inlets 431 cools the motor 47 while flowing toward the air outlets 432.

The controller 50 is a control device configured to control operations of the magnetic drill press 1A. The controller 50 controls driving of the motor 47, based on an on/off state of a motor switch (not shown in the drawings) that is manually operated by the user. The controller 50 is disposed above the motor 47, and below the air inlets 431 (or at substantially the same position as the air inlets 431 in the up-down direction). Thus, the air flow generated by the fan 48 can also cool the controller 50.

Note that the motor 47 and/or the controller 50 need not necessarily be accommodated in the housing 40 as in the above-described example, and may be accommodated inside the main body portion 3, for example.

Hereinafter, the detailed configuration of the battery attachment portion 33 is described.

As shown in FIG. 2 and FIG. 3, the battery attachment portion 33 is provided at a rear portion of the main body portion 3. The battery attachment portion 33 includes a housing recess 34 into which the battery 93 is partially inserted and fitted. More specifically, the housing recess 34 is defined by a bottom surface, left and right side surfaces, and a front surface, and is open upward. The depth of the housing recess 34 is set such that substantially half of the battery 93 in its lengthwise direction is covered when the battery 93 is inserted and fitted into the housing recess 34.

Further, as shown in FIG. 3 and FIG. 4, the battery attachment portion 33 includes a pair of rails 341, a locking recess 344, and a terminal portion 347.

As shown in FIG. 4, the rails 341 are provided at each of the side wall portions defining the left and right side surfaces of the housing recess 34, and extend in the up-down direction substantially in parallel to each other. The rails 341 are configured to slidably engage with the grooves 931 of the battery 93. By disposing the rails 341 in this way, the battery 93 is attached to the battery attachment portion 33 such that the lengthwise direction of the battery 93 is substantially aligned with (parallel to) the up-down direction of the magnetic drill press 1A.

Thus, a movement direction of the battery 93 when the battery 93 is attached (hereinafter referred to as a battery attachment direction) is a direction from the upper side to the lower side in the up-down direction. The movement direction of the battery 93 when the battery 93 is removed (hereinafter referred to as a battery removal direction) is from the lower side to the upper side in the up-down direction.

If the attachment direction and the removal direction of the battery 93 is the front-rear direction or the left-right direction, for example, and walls are surrounding the magnetic drill press 1A (i.e., walls are present forward, rearward, leftward, and rightward of the magnetic drill press 1A), the battery 93 may collide with one or some of the walls, and it may not be possible to appropriately move the battery 93. Thus, the attachment and removal of the battery 93 to and from the battery attachment portion 33 may become impossible. In contrast to this, since the magnetic drill press 1A is used in a state in which the contact surface 211 on the lower side of the magnetic base 2 is in contact with the workpiece 99 (refer to FIG. 3), there is a relatively low possibility of there being a wall or the like above the battery attachment portion 33. Thus, by defining the attachment direction and the removal direction of the battery 93 as described above, even when there are the walls around the magnetic drill press 1A, the attachment and removal of the battery 93 are easily performed.

As shown in FIG. 3, the locking recess 344 is provided at an upper end portion of the front wall portion defining the front surface of the housing recess 34. The locking recess 344 is configured to be engageable with the locking member 934 when the locking member 934 of the battery 93 is at the protruding position. When attaching the battery 93, the user slides the battery 93 in the attachment direction in a state in which the locking member 934 is disposed at the upper side and the rails 341 are engaged with the grooves 931. When the battery 93 reaches a predetermined position, the locking member 934 that has been provisionally moved to the retracted position returns to the protruding position, engages with the locking recess 344, and is locked. In this way, the battery 93 is held at the predetermined position.

As shown in FIG. 3 and FIG. 4, the terminal portion 347 is supported below the locking recess 344, at the front wall portion of the housing recess 34. The terminal portion 347 includes terminals 348 that can be electrically connected to terminals of the terminal portion 937 of the battery 93, and a support member 349 that supports the terminals 348. The support member 349 is supported by the main body portion 3. In response to the battery 93 being placed at the predetermined position of the battery attachment portion 33 as described above, the terminals of the battery 93 are electrically connected to the terminals 348 of the magnetic drill press 1A.

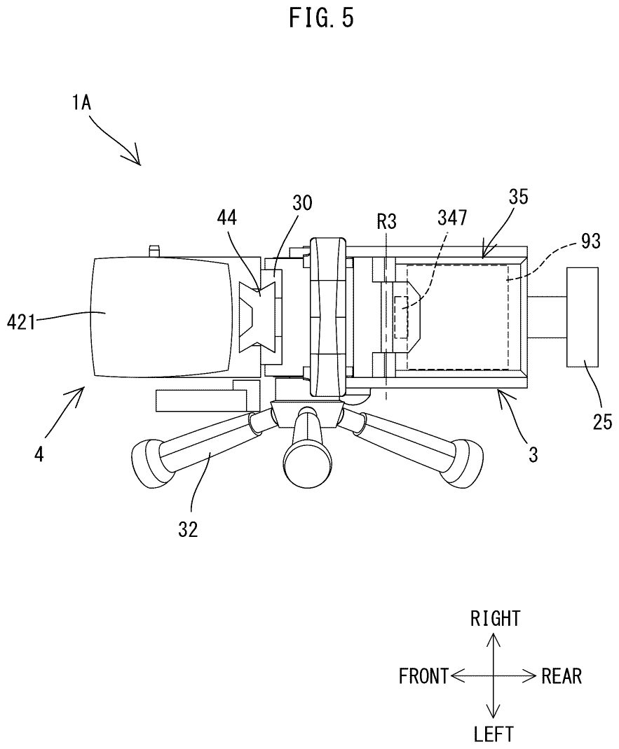

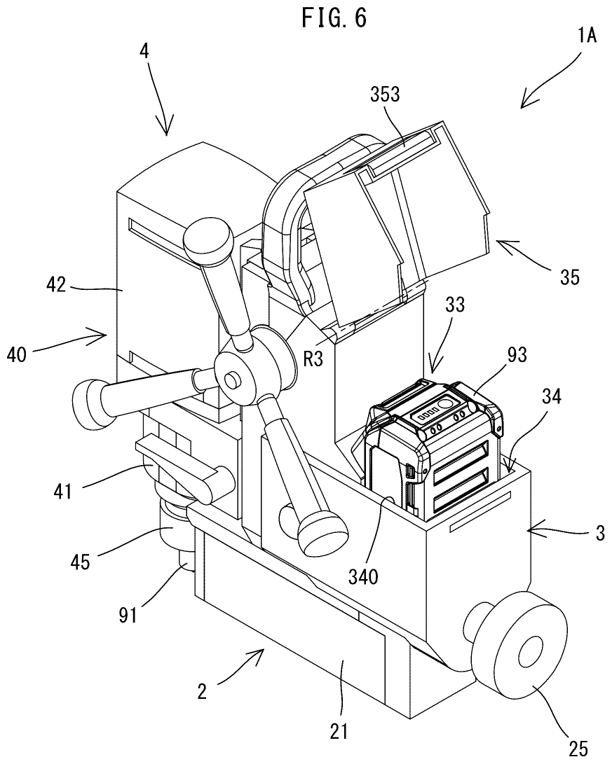

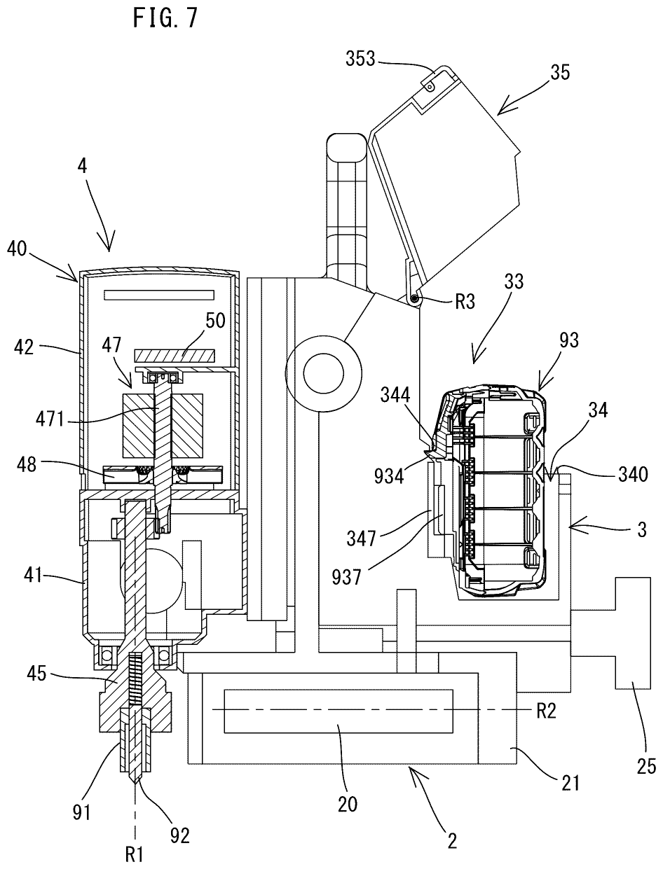

Furthermore, as shown in FIG. 2, FIG. 3, and FIG. 5, a cover 35 that is configured to cover the battery attachment portion 33 is provided at the main body portion 3. The cover 35 is configured to be displaced between a closed position (refer to FIG. 2, FIG. 3, and FIG. 5) of covering an opening 340 at the upper end of the housing recess 34, and an open position (refer to FIG. 6 and FIG. 7) of opening the opening 340 so that the battery 93 can be attached and removed. More specifically, the cover 35 is supported by the main body portion 3 to be pivotable (rotatable) around a pivot axis R3 extending in the left-right direction of the main body portion 3.

As shown in FIG. 2 and FIG. 3, the cover 35 according to the present embodiment is configured to substantially block (close) an entirety of the opening 340 of the housing recess 34 (i.e., substantially cover the entirety of the housing recess 34) when the cover 35 is at the closed position. Note that “substantially block the entirety of the opening 340 of the housing recess 34” herein means that substantially all the edge portion of the cover 35 is in contact with the main body portion 3, but can also refer to a case in which the edge portion is partially slightly spaced apart from the main body portion 3. As described above, substantially half, in the lengthwise direction, of the battery 93 attached to the battery attachment portion 33 protrudes upward from the housing recess 34, and is exposed to the outside of the housing recess 34. The cover 35 is configured to substantially cover an entirety of the exposed portion (section) of the battery 93 without interfering with the exposed portion of the battery 93 when the cover 35 is at the closed position.

Further, as described above, at the time of attachment and at the time of removal, the battery 93 is moved in the up-down direction relative to the battery attachment portion 33. Thus, as shown in FIG. 6 and FIG. 7, the cover 35 is configured to secure a necessary space, above the battery attachment portion 33, for attaching and removing the battery 93 when the cover 35 is at the open position.

Further, the cover 35 has a locking member 353 that is configured to lock the cover 35 to the main body portion 3 when the cover 35 is in the closed position. Of the edge portion of the cover 35, the locking member 353 is disposed at a substantially furthest position from the pivot axis R3 of the cover 35 at a section that comes into contact with the main body portion 3. The locking member 353 according to the present embodiment is a pivotable (rotatable) hook-shaped member that is engageable with the main body portion 3. The locking member 353 is configured to lock the cover 35 by engaging with the main body portion 3 while the cover 35 is at the closed position, so that the cover 35 cannot pivot (rotate) to the open position. Note that the mechanism for locking the cover 35 at the closed position to the main body portion 3 is not limited to the locking member 353, and can be changed as appropriate. For example, the cover 35 may employ a snap fit engagement to be locked to the main body portion 3 at the closed position.

When performing a drilling operation using the magnetic drill press 1A, metal chips are easily dispersed. However, the cover 35 disposed at the closed position can reduce the possibility that the chips enter into the battery attachment portion 33, and adhere to the terminals 348 of the terminal portion 347. In particular, in the present embodiment, since the cover 35 substantially blocks the opening 340 of the housing recess 34, the cover 35 can inhibit the chips from any direction from entering into the housing recess 34. In this way, it is possible to reliably reduce the possibility of a defect due to the chips attaching to the terminal portion 347.

Further, the cover 35 disposed at the closed position can reduce the possibility that the battery 93 is subject to an impact from the outside, and thus reduce the possibility that the battery 93 and/or the terminal portion 347 is damaged.

Furthermore, in the present embodiment, the cover 35 at the closed position is inhibited from pivoting to the open position by the locking member 353. Therefore, when the magnetic drill press 1A is in a posture in which the lower end of the spindle 45 is oriented (pointed) vertically upwards (i.e., in the opposite direction to the gravity direction) (hereinafter referred to as an upwardly oriented posture), the cover 35 can reduce the possibility of the battery 93 falling out.

Note that the cover 35 need not necessarily completely block (cover) the opening 340 as in the present embodiment. Specifically, it is sufficient that the cover 35 be configured to overlap at least an entirety of the terminal portion 347, and preferably, the entirety of the battery attachment portion 33 (the entirety of the battery 93 attached to the battery attachment portion 33) when the cover 35 is at the closed position and viewed from the upper side. The magnetic drill press 1A is relatively predominantly used in a posture in which the lower end of the spindle 45 is oriented vertically downward, that is, in the gravity direction (hereinafter referred to as a downwardly oriented posture). Therefore, owing to this configuration of the cover 35, it is possible to at least reduce the possibility of the chips falling toward the terminal portion 347 from the upper side of cover 35 when the magnetic drill press 1A is in the downwardly oriented posture.

Further, the cover 35 may be supported on the main body portion 3 so as to be slidable between the closed position and the open position, for example. Alternatively, the cover 35 may be detachable from main body portion 3 (i.e., completely separable from the main body portion 3).

Further, the battery attachment portion 33 need not necessarily include the housing recess 34, and may include only the rails 341, the locking recess 344, and the terminal portion 347. In this case, since the exposed portion of the battery 93 becomes larger, the cover 35 is preferably configured to substantially cover an entirety of the exposed portion of the battery 93.

Note that it is sufficient that the magnetic drill press 1A according to the present embodiment be able to attract the workpiece 99 to the contact surface 211 and fix the workpiece 99 to the contact surface 211 by selectively causing the magnetic force to act on the workpiece 99. Therefore, the type of the magnet 20 to be employed and/or a switching method of the strength of the magnetic force are not particularly limited.

For example, the magnet 20 may be an electromagnet. In such an embodiment, the controller 49 may switch the state of the electromagnet between a fixing state and a non-fixing state by controlling energization and de-energization of the electromagnet. Further, the controller 49 may control the strength of the magnetic force acting on the workpiece 99. When the electromagnet is employed, the manipulation member 25 may be an information input device (a push button switch, a touch screen, for example) that is electrically connected to the controller 49. Further, the above-described manipulation member 25 need not necessarily be provided on the main body portion 3, and may be provided on the magnetic base 2.

A correspondence relationship between each of structural elements (features) of the present embodiment and each of structural elements (features) of the present disclosure or the present invention is indicated below. However, each of the structural elements (features) of the embodiment is merely an example and does not limit each of the structural elements (features) of the present disclosure or present invention.

The magnetic drill press 1A is an example of a “magnetic drill press”. The magnetic base 2 is an example of a “magnetic base”. The main body portion 3 is an example of a “main body portion”. The drill unit 4 and the spindle 45 are an example of a “drill unit” and a “spindle”, respectively. The battery attachment portion 33 and the battery 93 are an example of a “battery attachment portion” and a “battery”, respectively. The rails 341 and the terminal portion 347 are an example of a “rail” and a “terminal portion”, respectively. The closed position and the open position of the cover 35 are an example of a “first position” and a “second position”, respectively. The housing recess 34 and the opening 340 are an example of a “recess” and an “opening”, respectively. The locking member 353 is an example of a “locking member”. Further, the battery attachment portion 33 is an example of a “battery housing portion”. The rail 30 is an example of a “guide portion”. The rack 44 is an example of a “guided portion”.

### Second Embodiment

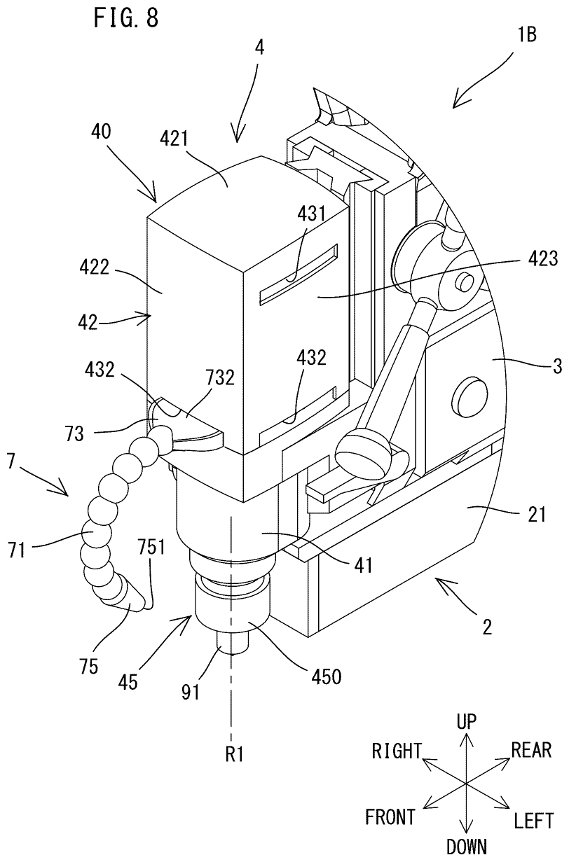

Hereinafter, a magnetic drill press 1B according to a second exemplary embodiment is described with reference to FIG. 8 to FIG. 10.

As shown in FIG. 8, the magnetic drill press 1B according to the second embodiment differs from the magnetic drill press 1A according to the first embodiment in that the magnetic drill press 1B includes an outlet nozzle 7, and the remaining configuration is substantially the same as that of the magnetic drill press 1A. Thus, in the following description, a description of configurations that are substantially the same as those of the first embodiment will be omitted or simplified. Note that, in the present disclosure, the same reference signs used for the structural elements of the magnetic drill press in the drawings indicate that those structural elements have the similar configuration (although they need not necessarily be strictly identical).

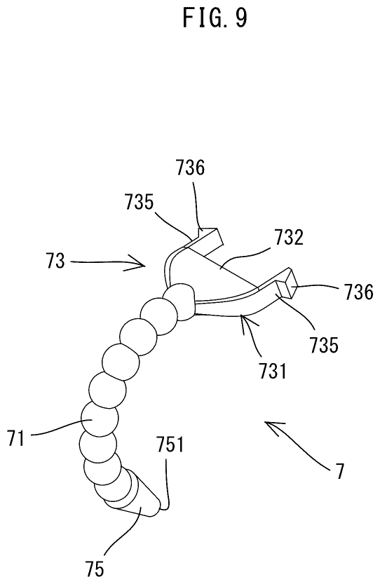

As shown in FIG. 8 and FIG. 9, the outlet nozzle 7 according to the present embodiment includes a hose 71, a connector 73 coupled to one end of the hose 71, and a nozzle portion 75 coupled to the other end of the hose 71.

The hose 71 is a tubular member that is at least partially flexible. In the present embodiment, a so-called flexible joint hose is employed as the hose 71. The flexible joint hose is a known hose formed by a plurality of synthetic resin parts coupled to each other via spherical surfaces of the parts. The flexible joint hose can freely change its overall shape by changing angles between adjacent parts, and can maintain its curved shape. Further, the parts may be detachably coupled to each other.

The connector 73 is configured to be detachably engaged with the air outlet 432 of the housing 40 of the drill unit 4 (refer to FIG. 8). More specifically, the connector 73 includes a hollow portion 731 that has an internal space communicated with a flow path inside the hose 71, and two latching pieces 735 that protrude from the hollow portion 731. A first end of the hollow portion 731 is coupled to the hose 71. An end portion 732 on the opposite side from the first end coupled to the hose 71 is shaped like a flat tube that conforms to the air outlet 432. The latching pieces 735 protrude in an axial direction of the hollow portion 731, from two ends in the lengthwise direction of the flat end portion 732. The latching pieces 735 can bend toward and away from each other (i.e., in the lengthwise direction of the end portion 732). Protrusions (tabs) 736 are provided at tip ends of each of the latching pieces 735 such that the protrusions 736 protrude away from each other.

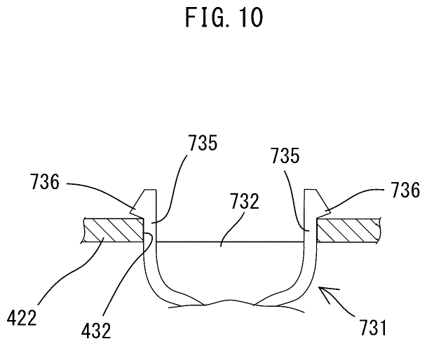

As shown in FIG. 10, the connector 73, and thus, the outlet nozzle 7 is attached to and held on the housing 40, by the latching pieces 735 being inserted through the air outlet 432, and the protrusions 736 being latched onto the inner surface of the housing 40 at positions adjacent to both ends, in the lengthwise direction, of the air outlet 432.

The nozzle portion 75 is a tubular member having an internal space communicated with the flow path inside the hose 71, and a discharge opening 751 for discharging air guided from the air outlet 432. The nozzle portion 75 has a tapered shape such that the air can be jetted at a specific target position.

Note that, in the present embodiment, the connector 73 is coupled to one of the parts of the hose 71 (the flexible joint hose) via the spherical surface of the part, in a similar manner to the coupling of the parts of the hose 71 with each other. Thus, the user can freely change the orientation of the connector 73 relative to the hose 71. Further, the connector 73 is detachably connected to the hose 71. Thus, by replacing the connector 73, the user can also use the outlet nozzle 7 not only on the magnetic drill press 1B, but also on a different magnetic drill press having an air outlet of a different shape. The nozzle portion 75 is also configured to be replaceable in a similar manner to the connector 73.

As described in the first embodiment, in the magnetic drill press 1B also, the cutting fluid can be supplied to the tool accessory 91 from the container, via the flow path inside the spindle 45. The cutting fluid can be appropriately supplied from the container when the magnetic drill press 1B is in the downwardly oriented posture, or when the magnetic drill press 1B is in a posture close to the downwardly oriented posture. In contrast to this, regardless of the posture of the magnetic drill press 1B, the outlet nozzle 7 can utilize the air flowing from the air outlet 432 to effectively cool the tool accessory 91.

Further, for example, when the cutting fluid supplied from the container can be used, or when the magnetic drill press 1B is not in use (during transport or storage, for example), the outlet nozzle 7 can be removed from the air outlet 432. Further, the outlet nozzle 7 can be selectively coupled to one of the air outlets 432 of the magnetic drill press 1B. Thus, for example, when there is an obstruction (a wall, for example) adjacent to the magnetic drill press 1B, the user can attach the outlet nozzle 7 to any one of the air outlets 432 that does not interfere with the obstruction, and use the outlet nozzle 7. The manner of coupling the outlet nozzle 7 to the air outlet 432 is not limited to the above-described example, and may be changed, for example, to threaded engagement, bayonet coupling, or the like.

Further, in the present embodiment, since the flexible joint hose is employed as the hose 71, the outlet nozzle 7 has an advantage of being able to stably guide the air to a desired position. However, in place of the flexible joint hose, a general metal or synthetic resin flexible hose may be employed as the hose 71. In this case also, the flexible hose can preferably hold its shape.

In another embodiment in which the hose 71 cannot hold its shape, a nozzle holder may be provided at a lower end portion of the spindle housing portion 41. The nozzle holder may be detachably coupled to the nozzle portion 75 or the hose 71, for example, and is configured to hold the nozzle portion 75 or the hose 71 at an appropriate position. Note that the nozzle holder may be removable from the spindle housing portion 41. Further, the nozzle holder may be configured such that the position at which the nozzle portion 75 or the hose 71 is held can be changed in a circumferential direction around the rotation axis R1.

The present embodiment describes the outlet nozzle 7 configured to be attached to one of the air outlets 432. In another embodiment, the outlet nozzle 7 may be configured to (i) cover a plurality of air outlets, and (ii) be connected to at least one of the air outlets. In such an embodiment, it is possible to use the air flowing from the air outlets into the outlet nozzle to cool the tool accessory 91. Further, the arrangement and number of the air inlets 431 and the air outlets 432 according to the present embodiment are merely examples, and can be changed as appropriate.

Note that the same changes as those described in relation to the first embodiment may also be applied to the magnetic drill press 1B according to the present embodiment. Further, the cover 35 may be omitted from the magnetic drill press 1B.

In view of the gist of the present disclosure, the above-described embodiments and modifications thereof, the following Aspects 1 to 6 are provided. At least one of the Aspects 1 to 6 can be employed individually, or in combination with at least one of the above-described embodiments, the modifications thereof, and the invention disclosed in each of the claims.

### Aspect 1

A magnetic drill press comprising:
a magnetic base configured to be selectively fixed to a workpiece by magnetic force;
a main body portion coupled to the magnetic base; and
a drill unit supported by the main body portion to be movable in a first direction, wherein the drill unit includes:
   a motor;
   a spindle configured to detachably hold a tool accessory, and configured to be rotated by the motor around a rotation axis extending in the first direction;
   a fan configured to be rotated by the motor;
   a housing accommodating the motor, the spindle, and the fan, and including at least one air inlet and at least one air outlet; and
   an outlet nozzle coupled to the at least one air outlet and including a tubular portion that is at least partially flexible.

According to the present aspect, air flowing into the housing through the at least one air inlet and flowing out through the air outlet in response to the rotation of the fan can be discharged via the outlet nozzle coupled to the at least one air outlet to be utilized to cool the tool accessory.

### Aspect 2

The magnetic drill press according to Aspect 1, wherein the outlet nozzle is detachably coupled to the at least one air outlet.

According to the present aspect, when a cutting fluid supplied from a container can be used, or when the magnetic drill press is not being used, the outlet nozzle can be removed, thus improving convenience.

### Aspect 3

The magnetic drill press according to Aspect 2, wherein
the at least one air outlet includes a plurality of air outlets disposed at mutually different positions in a circumferential direction around the rotation axis of the spindle, and
the outlet nozzle is configured to be selectively coupled to one of the plurality of air outlets.

According to the present aspect, a user can couple the outlet nozzle to at one of the air outlets at an appropriate position and use the outlet nozzle, depending on a working environment of the magnetic drill press (depending on the position of an obstruction in the proximity, for example), and thus, convenience is improved.

### Aspect 4

The magnetic drill press according to Aspect 2 or 3, wherein the outlet nozzle is configured to be coupled to the at least one air outlet, without using a separate auxiliary device.

According to the present aspect, the user can easily couple the outlet nozzle to the air outlet. Note that, as a manner of coupling the outlet nozzle to the air outlet, for example, a snap fit using flexible latching pieces, threaded engagement, and bayonet coupling can be employed.

### Aspect 5

The magnetic drill press according to any one of Aspects 2 to 4, wherein
the outlet nozzle further includes:
   a connector configured to be detachably coupled to the at least one air outlet; and
   a nozzle portion having a discharge opening, and
at least one of the connector and the nozzle portion is detachably coupled to the tubular portion.

According to the present aspect, since the user can replace the connector and/or the nozzle portion in accordance with a configuration of the air outlet of the magnetic drill press, or a size and the like of the desired discharge opening, convenience is improved.

### Aspect 6

The magnetic drill press according to any one of Aspects 1 to 5, wherein the tubular portion is configured to hold its shape in a curved state.

According to the present aspect, the outlet nozzle can stably guide the air to a desired position.

Furthermore, in view of another non-limiting object to provide techniques for distinguishing whether or not the magnetic drill press is in a stable state, the present disclosure also provides the following Aspects A1 to A13, as well as a third exemplary embodiment and a fourth exemplary embodiment.

### Aspect A1

A magnetic drill press comprising:
a motor;
a drill unit including at least a spindle, the spindle being configured to detachably hold a tool accessory and to be driven to rotate around a first axis by the motor;
a main body portion configured to support the drill unit to be movable in a first direction parallel to the first axis;
a magnetic base coupled to the main body portion, and configured to be selectively fixed to a workpiece by magnetic force; and
a sensor configured to detect at least one of (i) information corresponding to falling of the magnetic drill press, (ii) information corresponding to vibration of the drill unit, or (iii) information corresponding to a posture of the magnetic drill press.

The magnetic drill press according to the present aspect can detect, using the sensor, at least one of (i) the information corresponding to the falling of the magnetic drill press, (ii) the information corresponding to the vibration of the magnetic drill press, or (iii) the information corresponding to the posture of the magnetic drill press. These pieces of information are information useful to indicate whether or not the magnetic drill press is in a stable state. Thus, utilizing the information detected by the sensor can contribute to improvement of the magnetic drill press.

### Aspect A2

The magnetic drill press according to Aspect A1, further comprising:
a control device configured to control operation of the magnetic drill press, based on the information detected by the sensor, wherein
the control device is configured to stop driving of the motor when the information indicates the falling of the magnetic drill press.

According to the present aspect, it is possible to inhibit the tool accessory from being driven to rotate in a state in which the magnetic drill press is separated from the workpiece due to falling. Note that the control device can be embodied as at least one processor/processing circuit and a memory, for example.

### Aspect A3

The magnetic drill press according to Aspect A1 or Aspect A2, further comprising:
a control device configured to control operation of the magnetic drill press, based on the information detected by the sensor, wherein
the control device is configured to stop driving of the motor when the information indicates that the vibration of the drill unit exceeding a predetermined threshold value.

Since the drill unit is supported by the main body portion so as to be movable in the first direction, unexpected looseness may occur due to slackness in the coupling of the support structure caused by the operation of the drill unit, and this can result in vibration of the drill unit. Accuracy of the hole formed by the tool accessory tends to deteriorate as the vibration becomes larger. According to the present aspect, since the driving of the motor is stopped when the vibration becomes severe to a certain extent, the user can take necessary measures to check the looseness of the support structure.

### Aspect A4

The magnetic drill press according to any one of Aspect A1 to Aspect A3, further comprising:
a control device configured to control operation of the magnetic drill press, based on the information detected by the sensor, wherein
the sensor is configured to detect, as the posture of the magnetic drill press, a first posture in which the magnetic base is placed on the workpiece, and a second posture different from the first posture, and
the control device is configured to control the operation of the magnetic drill press using a different mode when the information indicates that the magnetic drill press is in the second posture to that when the information indicates that the magnetic drill press in in the first posture.

When the magnetic drill press is in the first posture in which the magnetic base is placed on the workpiece (is supported on the workpiece), the magnetic drill press can be considered to be in a stable state compared to when the magnetic drill press is in another posture. Thus, by controlling the operations differently when the magnetic drill press is in the first posture and when the magnetic drill press is in the second posture, the control device can realize rational control.

### Aspect A5

The magnetic drill press according to Aspect A4, further comprising:
a first detector configured to detect a fastener that is configured to couple the main body portion or the magnetic base with the workpiece, when the fastener is attached to the main body portion or the magnetic base, wherein
the control device is configured to (i) drive the motor irrespective of a detection result of the first detector when the information indicates that the magnetic drill press is in the first posture, and (ii) drive the motor based on a condition that the fastener is detected by the first detector when the information indicates that the magnetic drill press is in the second posture.

The fastener is an auxiliary tool used for inhibiting the magnetic drill press from becoming displaced from the workpiece. In the present aspect, when the magnetic drill press is in the second posture, the motor is not driven unless the fastener is attached. It is thus possible to inhibit the magnetic drill press from being driven when it is in an unstable state. Note that a microswitch, or a load sensor can be employed as the first detector, for example.

### Aspect A6

The magnetic drill press according to any one of Aspect A1 to Aspect A5, further comprising:
an indicator configured to perform notification of detection information detected by the sensor, or of information based on the detection information.

According to the present aspect, the user can use the information indicated by the indicator to easily recognize the state of the magnetic drill press, and can take appropriate measures.

### Aspect A7

The magnetic drill press according to any one of Aspect A1 to Aspect A6, wherein the sensor is an acceleration sensor or an angular velocity sensor.

According to the present aspect, an existing easily available sensor can be utilized to detect at least one of (i) the information corresponding to the falling of the magnetic drill press, (ii) the information corresponding to the vibration of the drill unit, and (iii) the information corresponding to the posture of the magnetic drill press.

### Aspect A8

The magnetic drill press according to Aspect A7, wherein the sensor is a single (only one) acceleration sensor, and is configured to detect (i) the information corresponding to the falling of the magnetic drill press, (ii) the information corresponding to the vibration of the drill unit, and (iii) the information corresponding to the posture of the magnetic drill press.

According to the present aspect, it is possible to detect the various types of information useful for the control of the magnetic drill press, with a small number of components compared to detection of each of the pieces of information using individual sensors.

### Aspect A9

The magnetic drill press according to any one of Aspect A1 to Aspect A8, further comprising:
a control device configured to control operation of the magnetic drill press, based on the information detected by the sensor; and
a second detector configured to detect whether the tool accessory held by the spindle is within a predetermined distance from the workpiece, wherein
the control device is configured to drive the motor at a predetermined first speed, in response to the second detector detecting that the tool accessory is within the predetermined distance from the workpiece.

According to the present aspect, it is possible to drive the motor at a rotation speed appropriate for a processing operation when the tool accessory approaches the workpiece in accordance with the movement of the drill unit and the tool accessory is disposed within the predetermined distance.

### Aspect A10

The magnetic drill press according to Aspect A9, further comprising:
a motor switch configured to be manually operated by a user, wherein
the control device is configured to (i) start the driving of the motor at a second speed lower than the first speed, in response to the motor switch being turned on, and (ii) change the rotation speed of the motor from the second speed to the first speed, in response to the second detector detecting that the tool accessory is within the predetermined distance from the workpiece.

According to the present aspect, it is possible to suppress unnecessary power consumption, compared to when the motor is started to be driven at the first speed immediately in response to the switch being turned on. Note that it is sufficient that the first speed be higher than the second speed, but the first speed is preferably a highest speed of the motor.

### Aspect A11

The magnetic drill press according to Aspect A9 or Aspect A10, wherein
the spindle includes an insertion hole extending along the first axis, and configured to receive a portion of a pilot pin held to be movable along the first axis by the tool accessory, and
the second detector is a load sensor disposed inside the insertion hole of the spindle to receive a load from the pilot pin.

The pilot pin is a known component for positioning the rotation axis of the spindle of the magnetic drill press at a desired position, and is detachably held by the tool accessory and used. According to the present aspect, the load sensor can detect that the tool accessory is within the predetermined distance from the workpiece, based on the load received from the pilot pin.

### Aspect A12

The magnetic drill press according to Aspect 9 or Aspect 10, wherein the second detector is a ranging sensor or a proximity sensor disposed at the drill unit.

According to the present aspect, it is possible to detect that the tool accessory is within the predetermined distance from the workpiece, using a simple configuration.

### Aspect A13

A magnetic drill press comprising:
a motor;
a drill unit including at least a spindle, the spindle being configured to detachably hold a tool accessory and to be driven to rotate by the motor;
an intermediate portion movably supporting the drill unit;
a magnetic base coupled to the intermediate portion and configured to be selectively fixed to a workpiece by magnetic force; and
an acceleration sensor or an angular velocity sensor.

Using the acceleration sensor or the angular velocity sensor, the magnetic drill press according to the present aspect can detect information relating to movement or a posture of the magnetic drill press, for example. These pieces of information are useful information indicating whether or not the magnetic drill press is in a stable state. Thus, it is possible to contribute to improving the magnetic drill press by utilizing the information detected by the acceleration sensor or the angular velocity sensor.

### Third Embodiment

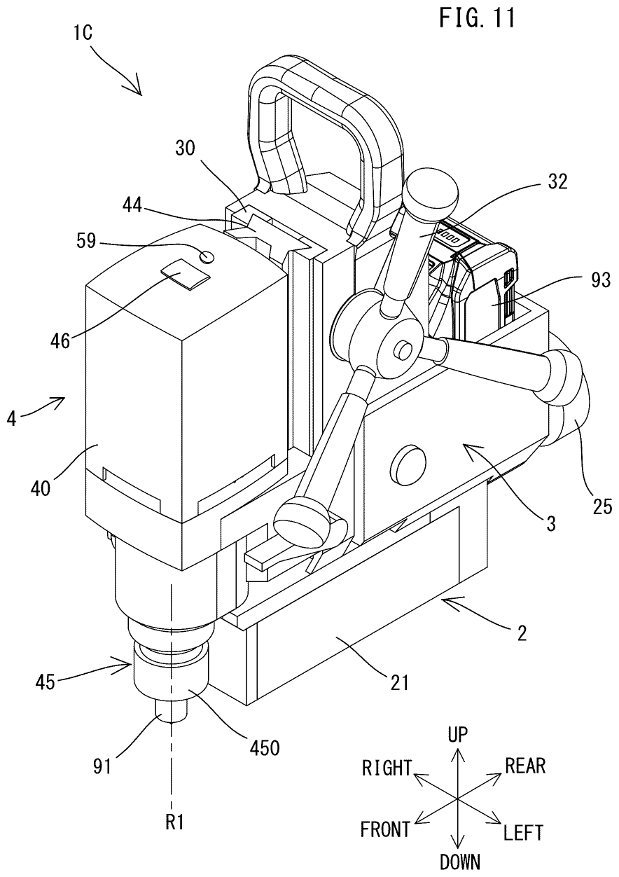

A magnetic drill press 1C according to the third exemplary embodiment will be described with reference to FIG. 11 to FIG. 14. Note that part of the configuration of the magnetic drill press 1C is substantially the same as that of the magnetic drill press 1A according to the first embodiment. Thus, in the following description, a description of configurations that are substantially the same as those of the first embodiment will be omitted or simplified. Note that this point also applies to a fourth embodiment to be described later.

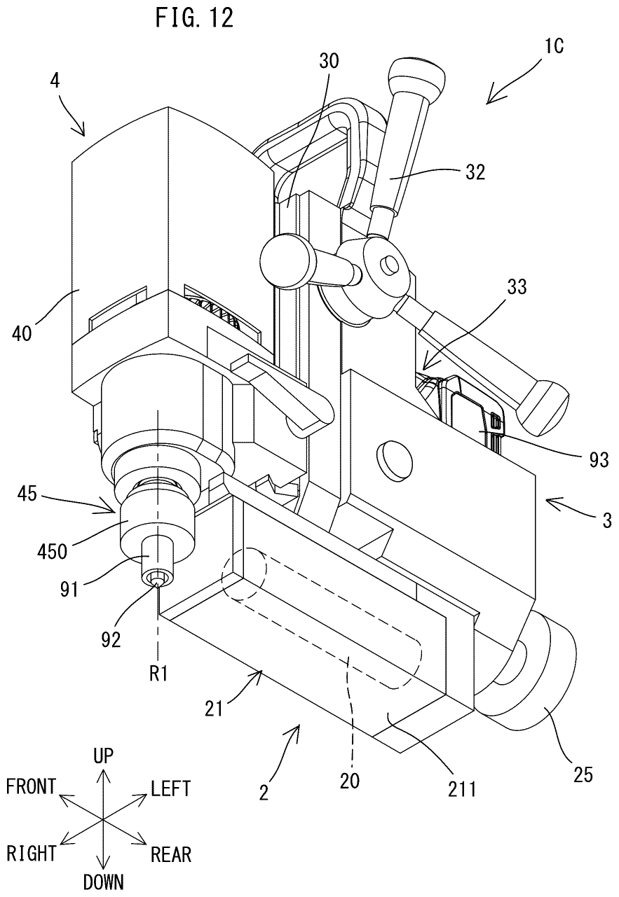

As shown in FIG. 11 and FIG. 12, the magnetic drill press 1C includes the magnetic base 2 configured to be selectively fixed to the workpiece by the magnetic force, the main body portion 3 coupled to the magnetic base 2, and the drill unit 4 supported by the main body portion 3, in the same manner as the magnetic drill press 1A according to the first embodiment.

The main body portion 3 includes the battery attachment portion 33 configured to detachably receive the battery 93. The battery 93 is, for example, a rechargeable battery that can also be used in various power tools other than the magnetic drill press 1C. In the present embodiment, the battery attachment portion 33 is disposed at the rear end portion of the main body portion 3, and is configured such that the battery 93 is attached to the battery attachment portion 33 from above. Note, however, that the attachment direction of the battery 93 may be another direction. Further, the magnetic drill press 1C may be configured to operate using power supplied from an external commercial power supply via a power cord, in place of the battery 93.

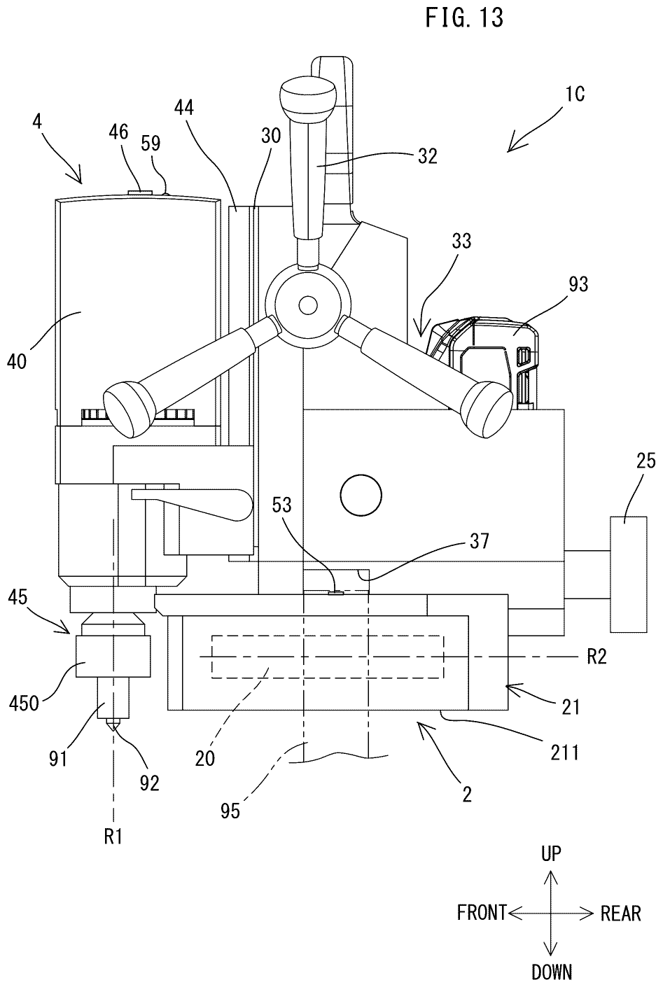

As shown in FIG. 13, in the present embodiment, in the up-down direction, a gap (passage) extending in the left-right direction is secured between a portion of the main body portion 3 and the magnetic base 2. This gap serves as a slot 37 through which a fastener 95 is passed. The fastener 95 according to the present embodiment is a long thin strap. In place of this example, a chain can be employed, for example. The magnetic drill press 1C is reliably coupled to the workpiece so as not to separate from the workpiece, by the fastener 95 being passed through the slot 37 and tightened around the magnetic base 2 and the workpiece.

The magnetic drill press 1C can be used in the downwardly oriented posture when the magnetic drill press 1C is placed on the workpiece such that the contact surface 211 of the magnetic base 2 (and thus the tip end of the tip tool 91) faces (is oriented) vertically downward, i.e., in the gravity direction. When the magnetic drill press 1C is in the downwardly oriented posture, the magnetic drill press 1C is in the stable state, and the possibility of falling from the workpiece is low.

On the other hand, when the magnetic drill press 1C is used in a posture other than the downwardly oriented posture, if the magnetic drill press 1C is not fixed or insufficiently fixed by the magnetic force, there is a possibility that the magnetic drill press 1C may fall. In particular, care is needed when the magnetic drill press 1C is used in (i) the upwardly oriented posture in which the contact surface 211 (and thus the lower end of the tool accessory 91) faces (is oriented) vertically upward, i.e., in a direction opposite to the gravity direction, (ii) a posture in which the contact surface 211 is generally parallel to the vertical direction (hereinafter simply referred to as a vertical posture), or (iii) an intermediate posture between the upwardly oriented posture and the vertical posture. Therefore, when the magnetic drill press 1C is used in the upwardly oriented posture, the vertical posture, or the intermediate posture between these postures, the use of the fastener 95 is recommended.

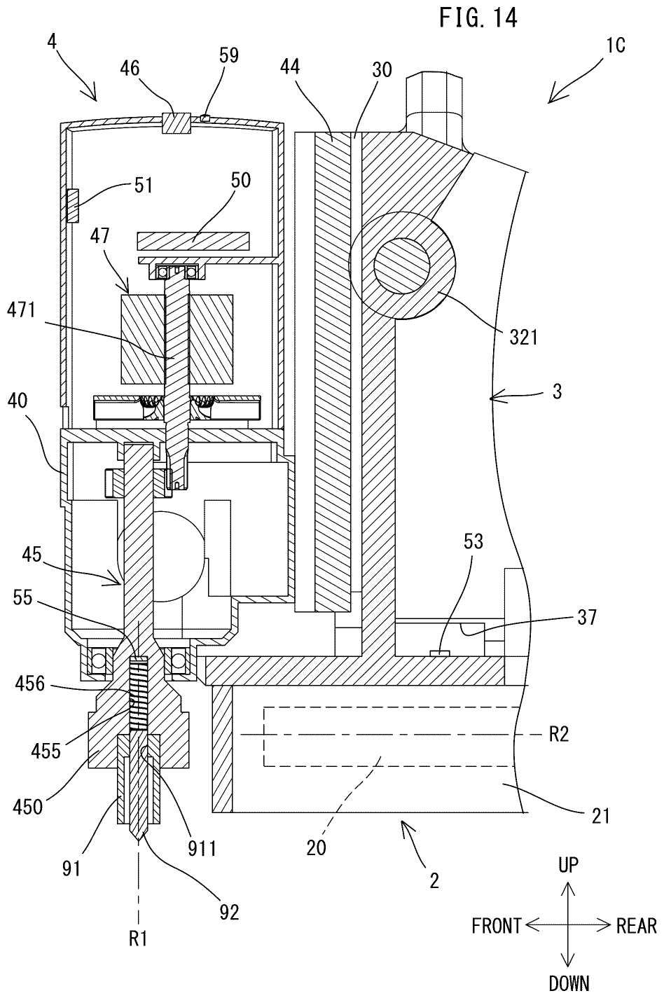

As shown in FIG. 13, in the present embodiment, a microswitch 53 that is configured to detect the attachment of the fastener 95 is disposed on the upper surface of the magnetic base 2 inside the slot 37. The microswitch 53 is configured to be normally maintained in an off state, and to be turned on when the fastener 95 is passed through the slot 37 and is tightened around the magnetic base 2 and the workpiece. The microswitch 53 is electrically connected to the controller 50 (refer to FIG. 14) to be described later, and outputs a signal indicating the on and off state. Note that a load sensor may be employed to detect the attachment of the fastener 95, in place of the microswitch 53.

As shown in FIG. 14, the drill unit 4 according to the present embodiment includes the housing 40, the spindle 45, the motor 47, and the controller 50. The spindle 45, the motor 47, and the controller 50 are accommodated in the housing 40.

The spindle 45 has the insertion hole 455 that extends upward in a straight line along the rotation axis R1, from the lower end of the spindle 45. The insertion hole 455 is configured to receive the pilot pin 92. A spring 456 for urging the pilot pin 92 is accommodated inside the insertion hole 455. When the tool accessory 91 holding the pilot pin 92 is attached to the tool attachment portion 450 of the spindle 45, an upper end portion of the pilot pin 92 is disposed inside the insertion hole 455, and the pilot pin 92 is urged downward by the spring 456.

In an initial state in which an upward force is not applied to the pilot pin 92, the lower end portion of the pilot pin 92 protrudes further downward of a lower end of the tool accessory 91. Thus, the user can adjust the position of the magnetic drill press 1C relative to the workpiece using the tip end of the pilot pin 92 as a marker. When the pilot pin 92 is pressed against the workpiece in the process of the drilling operation, the pilot pin 92 is pressed upward against the urging force of the spring 456.

The controller 50 is configured to control the operations of the magnetic drill press 1C. The controller 50 includes at least a control circuit mounted on a circuit board. In the present embodiment, the controller 50 is configured by a microcomputer including a CPU and a memory.

In the present embodiment, the controller 50 is electrically connected to the motor 47, a motor switch 46, an acceleration sensor 51, the microswitch 53, a load sensor 55, and an indicator lamp 59.

The motor switch 46 is configured to be manually operated by the user, in order to activate the motor 47. As shown in FIG. 11 and FIG. 14, in the present embodiment, the motor switch 46 is disposed at an upper end portion of the housing 40. The motor switch 46 is configured to switch between on and off in response to the manual operation by the user. A signal indicating an on or off state output from the motor switch 46 is used by the controller 50 to control the starting and stopping of the driving of the motor 47.

As shown in FIG. 14, the acceleration sensor 51 is attached to the housing 40. The acceleration sensor 51 according to the present embodiment detects (i) information corresponding to falling of the magnetic drill press 1C, (ii) information corresponding to vibration of the drill unit 4, and (iii) information corresponding to the posture of the magnetic drill press 1C, and outputs corresponding signals. Specifically, the acceleration sensor 51 is a three-axis acceleration sensor, and detects acceleration in each of three mutually orthogonal directions (an X-axis direction, a Y-axis direction, and a Z-axis direction). The signals output from the acceleration sensor 51 are used for operational control of the magnetic drill press 1C by the controller 50, as described below, for example.

As the information corresponding to the falling of the magnetic drill press 1C, the acceleration sensor 51 can detect the acceleration in each of the three directions, for example. When the magnetic drill press 1C is in a free fall state, the acceleration is zero in each of the three directions, and a sum of these is substantially zero. In the present embodiment, when, based on the signals output from the acceleration sensor 51, the controller 50 determines that a state in which the sum of the acceleration in the three directions is zero (i.e., the free fall state) has continued for a predetermined period of time during the driving of the motor 47, the controller 50 stops the driving of the motor 47. By this type of control, it is possible to inhibit the rotational driving of the tool accessory 91 from continuing in a state in which the magnetic drill press 1C has become separated from the workpiece.

Further, as the information corresponding to the vibration of the drill unit 4, the acceleration sensor 51 can detect the acceleration in a direction intersecting the up-down direction, for example. This vibration of the drill unit 4 is, typically, vibration occurring as a result of looseness of the coupling structure between the main body portion 3 and the drill unit 4. As described above, in the present embodiment, the main body portion 3 and the drill unit 4 are coupled by the sliding engagement between the rail 30 and the rack 44. Generally, looseness is within a tolerance range at a time of shipment. However, if slackness or looseness of the coupling becomes larger due to use of the magnetic drill press 1C, vibrations increase mainly in the directions orthogonal to the up-down direction.

In the present embodiment, when, based on the signals output from the acceleration sensor 51, the controller 50 determines that the vibration in a predetermined direction (the left-right direction, for example) orthogonal to the up-down direction exceeds a predetermined threshold value during the driving of the motor 47, the controller 50 stops the driving of the motor 47. Owing to this type of control, it is possible to inhibit operations from being continued while the magnetic drill press 1C is in an unstable state. Further, it is possible to inhibit the shape and dimension of the hole formed by the tool accessory 91 from deviating significantly from a desired shape and dimension due to the vibration.

Further, the acceleration sensor 51 can detect a pitch angle or an angle of the rotation axis R1 relative to the gravity direction, as the information corresponding to the posture of the magnetic drill press 1C. The controller 50 can identify the posture of the magnetic drill press 1C based on the signals output from the acceleration sensor 51. As described above, if the fastener 95 is not attached when the magnetic drill press 1C is used in the upwardly oriented posture or the vertical posture, the possibility of falling increases. It is possible to distinguish whether or not the fastener 95 is attached from the detection result of the microswitch 53.

In the present embodiment, when the controller 50 determines that the magnetic drill press 1C is in the downwardly oriented posture, the controller 50 starts the driving of the motor 47 in response to the motor switch 46 being switched to the on state, irrespective of the detection result of the microswitch 53. On the other hand, when the controller 50 determines that the magnetic drill press 1C is in the posture other than the downwardly oriented posture (the upwardly oriented posture, the vertical posture, for example), the controller 50 drives the motor 47 only if the controller 50 determines, based on the signals output from the microswitch 53, that the fastener 95 is attached. In other words, when the magnetic drill press 1C is in the posture other than the downwardly oriented posture and the fastener 95 is not attached, the controller 50 does not drive the motor 47 even if the motor switch 46 is turned on. Thus, it is possible to inhibit the magnetic drill press 1C from being driven in the unstable state.

In the present embodiment, using the single acceleration sensor 51 alone, the three types of information corresponding to (i) the falling of the magnetic drill press 1C, (ii) the vibration of the drill unit 4, and (iii) the posture of the magnetic drill press 1C are detected and used in the operational control of the magnetic drill press 1C. Thus, the information useful for the control of the magnetic drill press 1C is detected, using a smaller number of components compared to when the respective pieces of information are detected using individual sensors.

As shown in FIG. 14, the load sensor 55 is mounted inside the insertion hole 455 of the spindle 45 described above. More specifically, the load sensor 55 is disposed at the upper side of the spring 456 inside an upper end portion of the insertion hole 455. The load sensor 55 receives a load in response to the pilot pin 92 being pressed against the workpiece and the spring 456 being compressed. The load detected by the load sensor 55 increases as the pilot pin 92 moves upward, that is, as the distance in the up-down direction between the tip end of the tool accessory 91 and the workpiece decreases.

During a period in which the controller 50 determines, based on the signals output from the load sensor 55, that the detected load is lower than a predetermined threshold value, namely, that the tool accessory 91 is spaced away from the workpiece by more than a predetermined distance, the controller 50 drives the motor 47 at an initial speed that is slower than the highest speed. When the load detected by the load sensor 55 becomes equal to or greater than the predetermined threshold value, that is, when the tool accessory 91 reaches the predetermined distance from the workpiece, the controller 50 increases the rotation speed of the motor 47 from the initial speed and drives the motor 47 at the highest speed. The threshold value of the load is preferably set to the load detected by the load sensor 55 when the tip end of the tool accessory 91 is spaced apart from the workpiece by 1 to 2 centimeters (cm), for example.

Note that the plurality of types of tool accessory 91 having differing lengths in the axial direction can be selectively attached to the magnetic drill press 1C, but the load sensor 55 can detect that the tool accessory 91 has reached the predetermined distance from the workpiece irrespective of the length of the tool accessory 91.

According to this type of control, after the user has turned on the motor switch 46, during a period in which the user operates the handle 32 and lowers the drill unit 4 until the tool accessory 91 reaches the predetermined distance from the workpiece, the rotation speed of the motor 47 is maintained at the low speed. Thus, it is possible to suppress unnecessary energy consumption. In particular, as in the present embodiment, when the battery 93 is the power supply, there is an advantage of lengthening the running time of the battery 93. Further, since the tool accessory 91 is rotated at the relatively low initial speed until the tool accessory 91 approaches the predetermined distance from the workpiece, it is possible to efficiently increase the rotation speed of the tool accessory 91 to the highest speed when the tool accessory 91 reaches the predetermined distance.

In the alternative to the above-described control, the controller 50 may be configured to not start driving of the motor 47 until the tool accessory 91 reaches the predetermined distance from the workpiece. In this case, there is an advantage of reducing the energy consumption even further than in the case of the low speed driving. Further alternatively, a plurality of loads may be set in advance in a stepwise manner corresponding to differing distances between the tool accessory 91 and the workpiece, and the controller 50 may increase the rotation speed of the motor 47 in a stepwise manner in accordance with the detected load.

The load sensor 55 can indirectly detect, by detecting the load received from the pilot pin 92, that the distance between the tip end of the tool accessory 91 and the workpiece is equal to or less than the predetermined distance. In place of this configuration, a contact switch may be disposed inside the insertion hole 455 of the spindle 45 such that a plunger of the switch is actuated by the upper end of the pilot pin 92 when the distance between the tip end of the tool accessory 91 and the workpiece is equal to or less than the predetermined distance.

The indicator lamp 59 is a device that notifies the user of information indicating the state of the magnetic drill press 1C. As shown in FIG. 11, the indicator lamp 59 according to the present embodiment is disposed on an upper surface of the housing 40. The indicator lamp 59 is configured by an LED, and is switched between an illuminated state and a non-illuminated state by the controller 50. The indicator lamp 59 is illuminated when an abnormality has occurred in the magnetic drill press 1C, or when it is necessary to prompt a user response, for example. Specifically, the indicator lamp 59 is illuminated when the motor 47 is stopped due to falling of the magnetic drill press 1C or due to the occurrence of vibration of the drill unit 4, or when the fastener 95 is not attached, as described above. Note that when there is a plurality of pieces of information to be notified, a plurality of LEDs may be provided corresponding to each of the pieces of information.

### Fourth Embodiment

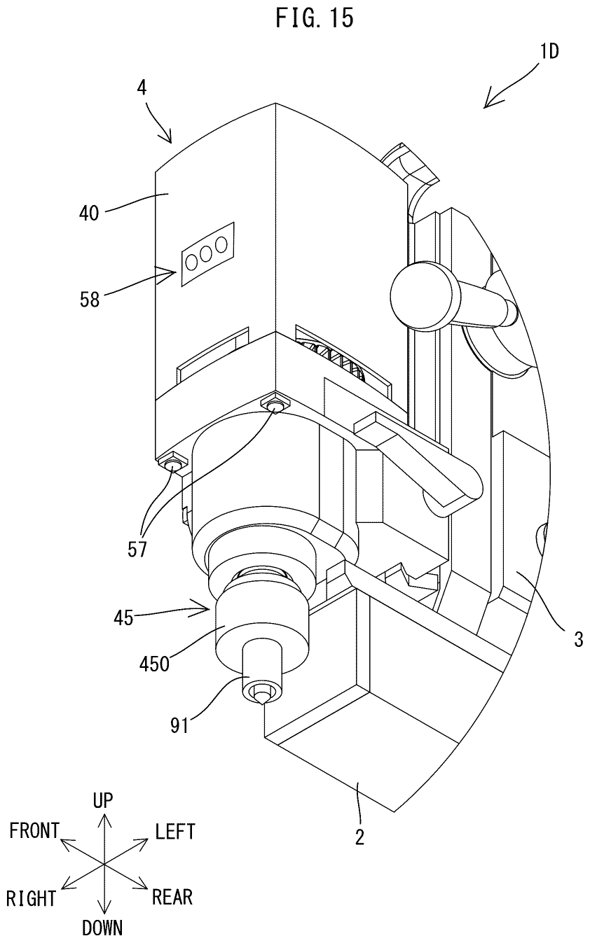

Hereinafter, a magnetic drill press 1D according to an exemplary fourth embodiment will be described with reference to FIG. 15.

The magnetic drill press 1D according to the fourth embodiment differs from the magnetic drill press 1C according to the third embodiment in that the magnetic drill press 1D includes a ranging sensor (distance sensor) 57 and a distance setting button 58, in place of the load sensor 55, and the remaining configuration is substantially the same as that of the magnetic drill press 1C. Thus, in the following description, a description of configurations that are substantially the same as those of the third embodiment will be omitted.

The ranging sensor 57 is attached to the housing 40 of the drill unit 4 such that the ranging sensor 57 faces downward. A photoelectronic sensor can be employed as the ranging sensor 57, for example. The ranging sensor 57 is electrically connected to the controller 50, and outputs a signal indicating a distance between the ranging sensor 57 and the workpiece.

The controller 50 starts the driving of the motor 47 when the motor switch 46 is turned on. Specifically, during a period in which the controller 50 determines, based on the signals output from the ranging sensor 57, that the detected distance is longer than a predetermined reference distance, the controller 50 drives the motor 47 at an initial speed that is slower than the highest speed. Alternatively, the controller 50 may be configured to not start the driving of the motor 47 during a period in which the controller 50 determines that the detected distance is longer than the predetermined reference distance. When the distance detected by the ranging sensor 57 is equal to or less than the predetermined reference distance, the controller 50 increases the rotation speed of the motor 47 from the initial speed and drives the motor 47 at the highest speed. Note that the reference distance is preferably set to the distance between the ranging sensor 57 and the workpiece when the tip end of the tool accessory 91 is spaced apart from the workpiece by 1 to 2 cm, for example.

The distance setting button 58 is a manipulation member that can be manually operated by the user for setting the reference distance, for example. In the present embodiment, the distance setting button 58 is disposed at a front end portion of the housing 40 such that a pressing operation can be performed thereon. The distance setting button 58 is electrically connected to the controller 50. As described above, the plurality of tool accessories 91 having the differing lengths in the axial direction can be selectively attached to the magnetic drill press 1D. A plurality of reference distances are stored in the memory of the controller 50 in association with each of the lengths of the types of the tool accessory 91. By pressing the distance setting button 58, the user can select the type of the tool accessory 91 that is to be actually used, and set the appropriate reference distance corresponding to the selected tool accessory 91. The controller 50 controls the driving of the motor 47 as described above, based on the reference distance set via the distance setting button 58.

The magnetic drill press 1D may include an indicator (an LED lamp, a display, for example) that is configured to notify the user of information relating to the tool accessory 91 selected by the user.

As described above, in the present embodiment, in a similar manner to the third embodiment, after the user has turned on the motor switch 46, during the period in which the user operates the handle 32 and lowers the drill unit 4 until the tool accessory 91 reaches a certain distance from the workpiece, the motor 47 is maintained in a low speed driving state or a stopped state. Thus, it is possible to suppress unnecessary energy consumption. Further, since it is possible to set the reference distance in accordance with the length of the tool accessory 91 that is to be actually used, the controller 50 can change the rotation speed of the motor 47 at an appropriate timing.

Note that, in the present embodiment, due to the attachment position on the housing 40, the ranging sensor 57 having a relatively long detection range (distance) is employed. However, if it is possible to set the attachment position to be lower than this example, a proximity sensor having a shorter detection range than the ranging sensor 57 may be employed. The controller 50 can increase the rotation speed of the motor 47, as described above, in response to the workpiece being detected within the predetermined distance by the proximity sensor.

A correspondence relationship between each of the structural elements (features) of the above-described third embodiment and fourth embodiment and each of the structural elements (features) of the invention described in the above-described Aspects A1 to A13 will be indicated below. However, each of the structural elements (features) of the embodiments is merely an example, and does not limit each of the structural elements (features) of the invention listed in the above-described Aspects A1 to A13.

Each of the magnetic drill presses 1C, 1D is an example of the “magnetic drill press”. The motor 47 is an example of a “motor”. The drill unit 4 and the spindle 45 are an example of the “drill unit” and the “spindle”, respectively. The main body portion 3 is an example of the “main body portion” and an “intermediate portion”. The magnetic base 2 is an example of the “magnetic base”. The acceleration sensor 51 is an example of a “sensor”. The controller 50 is an example of a “control device”. The microswitch 53 is an example of a “first detector”. The fastener 95 is an example of a “fastener”. The indicator lamp 59 is an example of an “indicator”. Each of the load sensor 55 and the ranging sensor 57 is an example of a “second detector”. The motor switch 46 is an example of a “motor switch”. The pilot pin 92 is an example of a “pilot pin”. The insertion hole 455 is an example of an “insertion hole”.

Note that the above-described embodiments are merely examples, and the magnetic drill press according to Aspect A1 to Aspect A13 is not limited to the magnetic drill press 1C, 1D exemplified above. For example, it is possible to add the non-limiting changes exemplified below. Further, at least one of these changes can be employed in combination with any one of the magnetic drill presses 1C and 1D exemplified in the embodiments and the invention listed in the above-described Aspects A1 to A13.

For example, the magnetic base 2 may have any configuration insofar as the workpiece can be attracted to and fixed to the contact surface 211 by causing the magnetic force generated by the magnet 20 to selectively act on the workpiece. Therefore, the type of the magnet 20 and/or the switching method of the strength of the magnetic force are not particularly limited.

For example, the magnet 20 may be an electromagnet, and the controller 50 may switch between a fixed state and a non-fixed state by controlling energization and de-energization of the electromagnet. Further, the controller 50 may control the strength of the magnetic force acting on the workpiece.

When the electromagnet is employed in place of the magnet 20, the manipulation member 25 may be an information input device (a push button switch, a touch screen etc., for example) that is electrically connected to the controller 50. The manipulation member 25 may be provided on the magnetic base 2 rather than on the main body portion 3.

The motor 47 and/or the controller 50 need not necessarily be included in the drill unit 4, and may be accommodated inside the main body portion 3. Further, the motor switch 46, the indicator lamp 59, and the distance setting button 58 may also be provided on the main body portion 3.

The acceleration sensor 51 need not necessarily detect all of the three types of information of (i) the falling of the magnetic drill press 1C, 1D, (ii) the vibration of the drill unit 4, and (iii) the posture of the magnetic drill press 1C, 1D. In other words, the acceleration sensor 51 may detect only one or two of the types of these pieces of information. In accordance with these changes, of the above-described control, the controller 50 may perform control corresponding to the detected information. Further, another sensor may be employed in place of the acceleration sensor 51, or in addition to the acceleration sensor 51. For example, as a sensor that detects the information corresponding to the vibration of the drill unit 4, an angular velocity sensor (gyroscope sensor) may be employed.

The controller 50 may perform control other than the control exemplified in the embodiments, based on a detection result of the acceleration sensor 51, or of the other sensor according to the above-described modified example. The following description lists non-limiting examples of control that can be employed.

For example, when an electromagnet is employed in the magnetic base 2, the controller 50 can control the strength of the magnetic force of the electromagnet in accordance with the posture of the magnetic drill press 1C, 1D detected by the acceleration sensor 51. Specifically, when it is detected that the magnetic drill press 1C, 1D is between the vertical posture and the upwardly oriented posture, the controller 50 may control the magnetic force to be strongest. When it is detected that the magnetic drill press 1C, 1D is in the downwardly oriented posture, the controller 50 may control the magnetic force to be smaller.

Although not illustrated due to being a well-known configuration, a container storing a liquid coolant can be attached to the magnetic drill press 1C, 1D. However, since it is presumed that the container is used when the magnetic drill press 1C, 1D is in the downwardly oriented posture, there is a possibility that the liquid coolant may leak when used in the upwardly oriented posture or the vertical posture. Therefore, the magnetic drill press 1C, 1D may be further include a detector (a microswitch, a load sensor, for example) that detects the attachment of the container. The controller 50 may notify the user of appropriate information based on a detection result of this detector, and on the posture of the magnetic drill press 1C, 1D detected by the acceleration sensor 51. Specifically, when it is detected that the container is attached and it is also detected that the magnetic drill press 1C, 1D is in the posture between the vertical posture and the upwardly oriented posture, the controller 50 may report an error. The indicator lamp 59 may be employed for such report or notification, for example.

Furthermore, in view of yet another non-limiting object to provide a magnetic drill press having improved convenience, the present disclosure also provides the following Aspects B1 to B25, as well as a fifth exemplary embodiment to a tenth exemplary embodiment.

### Aspect B1

A magnetic drill press comprising:
a main housing;
a drill unit including a drill and supported by the main housing to be movable relative to the main housing in an extending direction of a rotation axis of the drill;
a magnetic base including a permanent magnet and coupled to the main housing, the magnetic base being configured to allow displacement of the permanent magnet or a yoke disposed in the vicinity of the permanent magnet between a first position corresponding to a maximum state and a second position corresponding to a minimum state, to change a magnetic attraction force generated by action of a magnetic force of the permanent magnet and acting on a workpiece between the maximum state at which the magnetic attraction force is at a maximum and the minimum state at which the magnetic attraction force is at a minimum;
a first operation member movably coupled, directly or indirectly, to the permanent magnet or the yoke, and configured for a manual operation to change the magnetic attraction force between the maximum state and the minimum state;
a second operation member configured to be manually operated by a single touch to displace the permanent magnet or the yoke toward the first position; and
a drive device configured to (i) displace the permanent magnet or the yoke toward the first position and (ii) displace the first operation member toward a position corresponding to the maximum state, in response to a manual operation of the second operation member.

In general, the first operation member is configured to be displaced by a manual operation (typically, a rotating/turning operation) that is difficult through a single touch, in order to inhibit an operation that is contrary to an intention of the user. While this type of manual operation is easy when the magnetic drill press is used in the downwardly oriented posture, it is not easy when the magnetic drill press is used in a horizontally (laterally) oriented posture or the upwardly oriented posture, since a user needs to manipulate the first operation member while supporting the magnetic drill press by hand. On the other hand, according to the above-described magnetic drill press, even when the magnetic drill press is used in the horizontally oriented posture or the upwardly oriented posture, it may be possible for the user to displace the permanent magnet or the yoke in the direction to attach the magnetic base to the workpiece and cause the magnetic base to magnetically attach to the workpiece, by a manual operation with a single touch (hereinafter also referred to as a one-touch operation) using the hand supporting the magnetic drill press. Thus, convenience of the user is improved. The permanent magnet or the yoke may be displaced to the first position corresponding to the maximum state when the second operation member is operated. Alternatively, as long as the magnetic base can be magnetically attached to the workpiece, the permanent magnet or the yoke may be displaced to a position corresponding to an intermediate state between the minimum state and the maximum state.

The drive device may be an actuator, for example, that converts electrical energy into mechanical movement, or may be a mechanical mechanism that converts the displacement of the second operation member to a displacement of the permanent magnet or the yoke, and of the first operation member. As long as the permanent magnet is configured to be displaceable between the first position and the second position, the yoke can be omitted. In other words, the york is not an essential element of the magnetic drill press.

### Aspect B2

The magnetic drill press according to Aspect B1, wherein
the drive device includes an electric motor configured to be driven in response to the manual operation of the second operation member.

According to this configuration, (i) the second operation member, (ii) the permanent magnet or the yoke, and (iii) the first operation member can be operated in association with each other using a simple device configuration.

### Aspect B3

The magnetic drill press according to Aspect B2, wherein the second operation member takes the form of a push button.

According to this configuration, the user can manually operate the second operation member extremely easily, using a finger of one hand, while supporting the magnetic drill press with both hands, for example.

### Aspect B4

The magnetic drill press according to any one of Aspect B1 to Aspect B3, wherein the second operation member is disposed at an end portion (a first end portion) on an opposite side of the main housing from the drill unit in a direction (a first direction) in which the main housing and the drill unit are aligned.

According to this configuration, when positioning the magnetic drill press at an appropriate place on the workpiece, the user can operate the second operation member extremely easily, using a finger of the hand supporting the vicinity of the end portion (the first end portion) on the opposite side of the main housing from the drill unit, for example. The “end portion (first end portion)” may be, for example, a region that is one quarter of the magnetic drill press on the opposite side from the drill unit, in the direction (first direction) in which the main housing and the drill unit are aligned. Alternatively, the “end portion (first end portion)” may be a side surface of the magnetic drill press, on the opposite side from the drill unit, that intersects the direction (first direction) in which the main housing and the drill unit are aligned.

### Aspect B5

The magnetic drill press according to any one of Aspect B1 to Aspect B3, wherein the main housing and the drill unit are configured to be tiltable relative to the magnetic base about a tilting axis extending in a direction (first direction) in which the main housing and the drill unit are aligned.

According to this configuration, it is possible to form a hole extending in a direction that is tilted (angled) relative to the direction (first direction) in which the workpiece and the magnetic drill press are aligned.

### Aspect B6

The magnetic drill press according to any one of Aspect B1 to Aspect B3, further comprising:
a fall prevention belt attached to the main housing or the magnetic base, wherein
the fall prevention belt is an automatic-winding type belt and configured such that a length of a portion (section) of the fall prevention belt surrounding the workpiece is fixable by a manual operation with a single touch.

According to this configuration, it is possible to attach the fall prevention belt to the workpiece so as not to become loosened relative to the workpiece, without moving the hand supporting the magnetic drill press away from the magnetic drill press. Thus, the user convenience is improved.

### Aspect B7

The magnetic drill press according to Aspect B6, wherein the fall prevention belt is fixed to the main housing or the magnetic base to be non-detachable.

According to this configuration, the user does not need to mount the fall prevention belt to the main housing or the magnetic base. Thus, the user convenience is improved.

### Aspect B8

The magnetic drill press according to Aspect B7, wherein the fall prevention belt is fixed to the magnetic base to be non-detachable.

According to this configuration, compared to the configuration in which the fall prevention belt is attached to the main housing so as to be non-detachable, a portion of the fall prevention belt necessary to be extended to be wound around the workpiece becomes shorter. Thus, a gap is less likely to occur between the fall prevention belt and the workpiece, and it is thus possible to reduce loosening of the fall prevention belt relative to the workpiece.

### Aspect B9

The magnetic drill press according to any one of Aspect B1 to Aspect B3, wherein
the magnetic base includes a protruding member configured to be mechanically displaced, by a manual operation, between a retracted position closest to the main housing and a protruding position farthest from the main housing, and
the magnetic base is configured such that a contact area of the magnetic base with respect to the workpiece is changeable, depending on whether or not the protruding member is contactable with the workpiece, between when the protruding member is at the retracted position and when the protruding member is at the protruding position.

According to this configuration, utilizing the fact that the contact area of the magnetic base with respect to the workpiece can be changed, it is possible to reduce a force necessary for aligning the magnetic drill press with a position where the processing is performed (i.e., a position at which a hole is drilled, hereinafter simply referred to as a processing position) in various modes. Thus, the user convenience is improved.

### Aspect B10

The magnetic drill press according to Aspect B9, wherein
the protruding member is configured to be displaceable such that (i) the contact area between the workpiece and the magnetic base is a first contact area when the magnetic attraction force is in the maximum state, and (ii) the contact area between the workpiece and the magnetic base is a second contact area smaller than the first contact area when the magnetic attraction force is in the minimum state, and
the protruding member takes the form of a sphere.

According to this configuration, the user can easily align the magnetic drill press with the processing position using a small amount of force by utilizing rolling movement of the protruding member in the form of the sphere when the magnetic attraction force is in the minimum state. After the alignment, the user can cause the workpiece and the magnetic base to be firmly magnetically attached to each other, by displacing the protruding member such that the magnetic attraction force is in the maximum state.

### Aspect B11

The magnetic drill press according to Aspect B10, further comprising:
an interlocking mechanism configured to interlock the first operation member and the protruding member to cause the contact area between the workpiece and the magnetic base to be (i) the first contact area when the first operation member is at the position corresponding to the maximum state, and (ii) the second contact area when the first operation member is at a position corresponding to the minimum state.

According to this configuration, since the first operation member and the protruding member are interlocked, the user does not need to separately perform the operation to displace the protruding member and the operation of the first operation member. Thus, the user convenience is improved.

### Aspect B12

The magnetic drill press according to Aspect B9, further comprising:
a cam configured to press the protruding member to the protruding position when the cam is at a predetermined rotation angle position.

According to this configuration, the protruding member can be displaced between the retracted position and the protruding position using a simple configuration.

### Aspect B13

The magnetic drill press according to Aspect B9, wherein the protruding member takes the form of a sphere.

### Aspect B14

The magnetic drill press according to Aspect B9, wherein the protruding member is configured such that the position of the protruding member is selectively changeable between the protruding position and the retracted position when the magnetic attraction force is in the maximum state.

According to this configuration, by positioning the magnetic drill press while the protruding member is at the position at which the contact area between the workpiece and the magnetic base is relatively small, the user can perform the positioning while the workpiece and the magnetic base are magnetically attached to each other by the relatively small magnetic attraction force. Thus, the user can easily perform the positioning using a small force. After aligning the magnetic drill press with the appropriate processing position, the user can place the protruding member at the position at which the contact area between the workpiece and the magnetic base is relatively large, so that the workpiece and the magnetic base are firmly magnetically attached to each other.

### Aspect B15

The magnetic drill press according to any one of Aspect B1 to Aspect B3, further comprising:
a plate attachment formed from a material magnetically attachable to the magnetic base by the action of the magnetic force of the magnet, wherein
the plate attachment has such a size that the rotation axis of the drill intersects the plate attachment when the plate attachment is magnetically attached to the magnetic base.

According to this configuration, even when the workpiece is relatively small, the plate attachment magnetically attached to the magnetic base can be disposed on the workpiece, and a hole can be formed in the workpiece.

### Aspect B16

The magnetic drill press according to Aspect B15, wherein the plate attachment has a through hole through which the rotation axis of the drill passes when the plate attachment is magnetically attached to the magnetic base.

According to this configuration, when forming a through hole in the workpiece using the magnetic drill press, as long as the drilling operation is performed with the through hole of the workpiece and the through hole of the plate attachment being aligned, the plate attachment will not be damaged by the drilling operation. Thus, the useful life of the plate attachment is extended, and the user convenience is improved.

### Aspect B17

The magnetic drill press according to Aspect B16, wherein the plate attachment has a positioning recess or groove that at least partially conforms to a shape of the magnetic base.

According to this configuration, it is possible to easily position the magnetic base relative to the plate attachment.

### Aspect B18

The magnetic drill press according to any one of Aspect B1 to Aspect B3, further comprising:
a magnet attachment configured to be attachable, in a fixed manner, in the vicinity of a tip end of the drill.

According to this configuration, chips can be separated from a bit attached to the tip end of the drill and magnetically attached to the magnet attachment. Thus, the chips can be easily separated away from the bit and gathered (collected). It is thus possible to suppress a deterioration in visibility of the processing position caused by the chips.

### Aspect B19

The magnetic drill press according to Aspect B18, further comprising:
a cover disposed to surround a periphery of the drill, wherein
the magnet attachment is attached to the cover.

According to this configuration, by utilizing the cover, the magnet attachment can be disposed at an appropriate position spaced away from the tip end of the drill.

### Aspect B20

The magnetic drill press according to Aspect B19, wherein the magnet attachment has a shape detachably engageable with the cover.

According to this configuration, the chips can be easily eliminated by removing the magnet attachment, to which the chips are magnetically attached, from the cover.

### Aspect B21

A magnetic drill press comprising:
a main housing;
a drill unit including a drill and supported by the main housing to be movable relative to the main housing in an extending direction of a rotation axis of the drill; and
a magnetic base including a magnet and coupled to the main housing, the magnetic base being configured such that a magnetic attraction force generated by action of a magnetic force of the magnet and acting on a workpiece is changeable between a maximum state at which the magnetic attraction force is at a maximum, and a minimum state at which the magnetic attraction force is at a minimum, wherein
the magnetic base includes a protruding member configured to be mechanically displaced, by a manual operation, between a retracted position closest to the main housing and a protruding position farthest from the main housing, and
the magnetic base is configured such that a contact area of the magnetic base with respect to the workpiece is changeable, depending on whether or not the protruding member is contactable with the workpiece, between when the protruding member is at the retracted position and when the protruding member is at the protruding position.

Generally, the magnetic base is a heavy product. Therefore, aligning the center of the drill with a processing position at which the hole is to be drilled in the workpiece (hereinafter also referred to as alignment of the processing position) may require a relatively large force due to the need to slide the heavy magnetic base. Note that the center of the drill is equivalent to the center of the bit attached to the tip end of the drill and coincides with the rotation axis of the drill. According to the above-described magnetic drill press, by utilizing the fact that it is possible to change the contact area of the magnetic base with respect to the workpiece, it is possible to reduce a force required for the alignment of the processing position in various modes. Thus, the user convenience is improved.

The magnetic base may be configured such that the magnetic attraction force is at the maximum (in other words, the contact area between the workpiece and the magnetic base is at a maximum) when the protruding member is at the retracted position. Alternatively, the magnetic base may be configured such that the magnetic attraction force is at the maximum when the protruding member is at the protruding position.

### Aspect B22

A magnetic drill press comprising:
a main housing; and
a drill unit including a drill and supported by the main housing to be movable relative to the main housing in an extending direction of a rotation axis of the drill; and
a magnetic base including a magnet and coupled to the main housing, wherein
the main housing and the drill unit are configured to be tiltable relative to the magnetic base about a tilting axis extending in a direction in which the main housing and the drill unit are aligned.

According to this magnetic drill press, it is possible to move the drill unit relative to the main housing such that the rotation axis of the drill intersects the workpiece at an angle less than 90 degrees. Thus, in contrast to a known magnetic drill press configured to form only a hole extending in the direction in which the workpiece and the magnetic drill press are aligned, the magnetic drill press of this aspect can form a hole extending in a direction at an angle with respect to the direction in which the workpiece and the magnetic drill press are aligned. Thus, the user convenience is improved.

### Aspect B23

A magnetic drill press comprising:
a main housing;
a drill unit including a drill and supported by the main housing to be movable relative to the main housing in an extending direction of a rotation axis of the drill;
a magnetic base including a magnet and coupled to the main housing; and
a fall prevention belt attached to the main housing or the magnetic base, wherein
the fall prevention belt is an automatic-winding type belt configured such that a length of a portion (section) of the fall prevention belt surrounding the workpiece is fixable by a manual operation with a single touch.

Generally, a fall prevention belt is inserted through a through hole in the magnetic drill press such that a portion (section) of the fall prevention belt forms a ring surrounding the workpiece. Subsequently, the user adjusts the length of the portion forming the ring by pulling a section extending from the ring to shrink the ring, so that the fall prevention belt does not come loose from the workpiece, and the fall prevention belt is then fixed at the adjusted length. This type of length adjustment operation may be easy when the magnetic drill press is used in the downwardly oriented posture. On the other hand, the length adjustment operation may not be easy when the magnetic drill press is used in the horizontally oriented posture or the upwardly oriented posture, since the user needs to perform the length adjustment operation, in particular, to temporarily remove one of the hands from the magnetic drill press while supporting the magnetic drill press by hand. In contrast, according to the above-described magnetic drill press, the user can attach the fall prevention belt to the workpiece so that the fall prevention belt does not become loose from the workpiece, without moving the hand away from the magnetic drill press while supporting the magnetic drill press. Thus, the user convenience is improved.

### Aspect B24

A magnetic drill press comprising:
a main housing;
a drill unit including a drill and supported by the main housing to be movable relative to the main housing in an extending direction of a rotation axis of the drill;
a magnetic base including a magnet and coupled to the main housing; and
a plate attachment formed from a material magnetically attachable to the magnetic base by action of a magnetic force of the magnet, wherein
the plate attachment has such a size that the rotation axis of the drill intersects the plate attachment when the plate attachment is magnetically attached to the magnetic base.

According to this magnetic drill press, even when the workpiece is relatively small, the plate attachment magnetically attached to the magnetic base can be disposed on the workpiece, and the drilling operation can be performed with respect to the workpiece. For example, when the workpiece is formed of a magnetic material, the plate attachment becomes magnetized due to the magnetic force of the magnet of the magnetic base, and thus, the drilling operation can be performed on the workpiece in a state in which the plate attachment is fixed or latched to the workpiece by the magnetic attraction force of the plate attachment. Alternatively, when the workpiece is formed by a non-magnetic material, the drilling operation can be performed by disposing the workpiece on the plate attachment magnetically attached to the magnetic base and holding the workpiece by hand. In this case, the plate attachment can also be utilized as a workbench.

### Aspect B25

A magnetic drill press comprising:
a main housing;
a drill unit including a drill and supported by the main housing to be movable relative to the main housing in an extending direction of a rotation axis of the drill;
a magnetic base including a magnet and coupled to the main housing; and
a magnet attachment configured to be attachable, in a fixed manner, in the vicinity of a tip end of the drill.

Chips generated by the drilling operation normally have a long spiral shape. These chips are not cut partway along the length thereof, but usually rotate together with the bit attached to the tip end of the drill in a state of being entangled with the bit. These chips may cause deterioration in the visibility of the processing position (in other words, of the bit), and thus obstruct the drilling operation. In contrast, according to the above-described magnetic drill press, the chips can be separated from the bit and magnetically attached to the magnet attachment. When the spiral-shaped chips that rotate together with the bit are magnetically attached to the fixed magnet attachment, a shearing force acts on the chips, and the chips are cut partway along the length thereof. As a result, the magnet attachment can easily separate the chips from the bit and gather (collect) the chips. Thus, it is possible to suppress the deterioration in the visibility of the processing position caused by the chips. Thus, the user convenience is improved.

### Fifth Embodiment

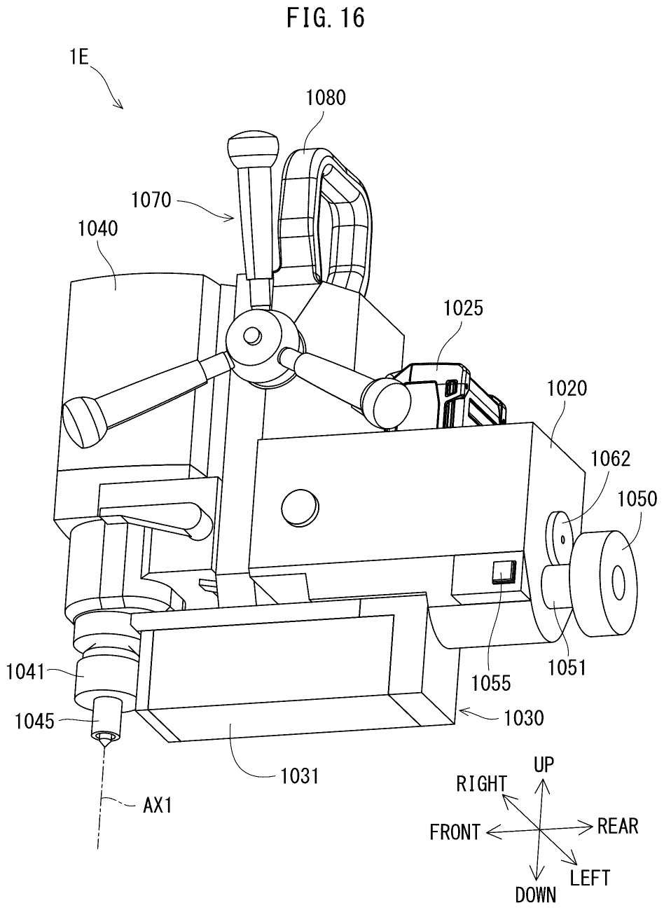

A magnetic drill press 1E according to an exemplary fifth embodiment will be described in specific detail with reference to FIG. 16 to FIG. 19. As shown in FIG. 16, the magnetic drill press 1E includes a main housing 1020, a magnetic base 1030, and a drill unit 1040. In the following description, a direction in which the main housing 1020 and the drill unit 1040 are aligned is defined as the front-rear direction of the magnetic drill press 1E. In the front-rear direction, the side on which the drill unit 1040 is positioned is defined as the front side of the magnetic drill press 1E, and the side on which the main housing 1020 is positioned is defined as the rear side of the magnetic drill press 1E. Further, a direction in which the main housing 1020 and the magnetic base 1030 are aligned is defined as the up-down direction of the magnetic drill press 1E. In the up-down direction, the side on which the main housing 1020 is positioned is defined as the upper side of the magnetic drill press 1E, and the side on which the magnetic base 1030 is positioned is defined as the lower side of the magnetic drill press 1E. Furthermore, the direction orthogonal to the front-rear direction and the up-down direction is defined as the left-right direction. In the left-right direction, the right side as seen from the rear side toward the front side is defined as the right side of the magnetic drill press 1E, and the opposite side thereto is defined as the left side of the magnetic drill press 1E.

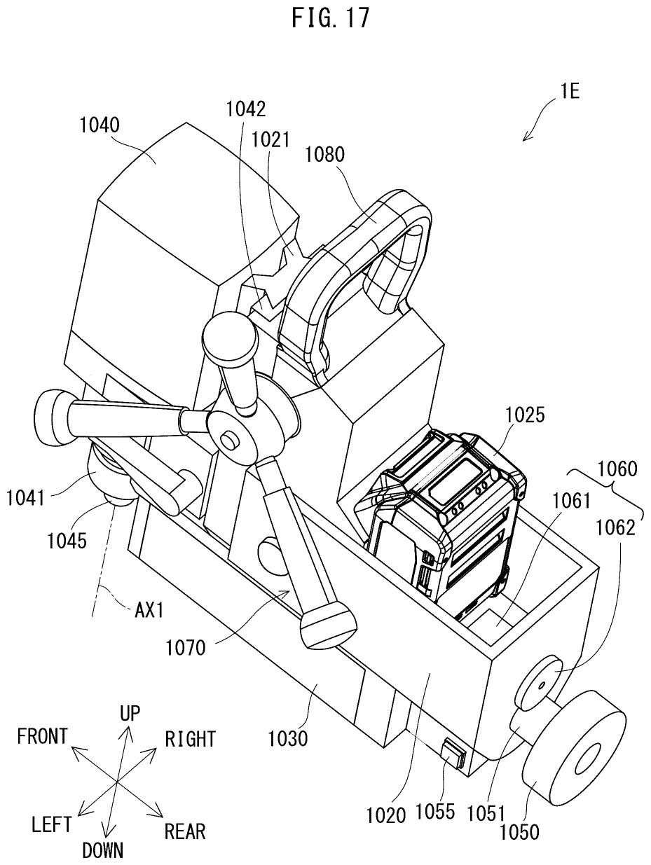

As shown in FIG. 16 and FIG. 17, the drill unit 1040 includes a drill 1041. A controller, a motor, and a speed reduction mechanism (none of which are shown in the drawings) are accommodated inside a housing of the drill unit 1040 that is positioned above the drill 1041. The controller controls activation and stopping of the motor, in response to a manual operation of an operation member (not shown in the drawings) for activating and stopping of the magnetic drill press 1E. The drill 1041 rotates around a rotation axis AX1 extending in the up-down direction by utilizing a rotational driving force transmitted from the motor via the speed reduction mechanism. A bit (tool accessory, working tool) 1045 for forming a hole is attached to a tip end (lower end) of the drill 1041.

The magnetic base 1030 has a substantially rectangular shape, and permanent magnets 1032 and 1033 (not shown in FIG. 16 and FIG. 17) are accommodated in the interior thereof. The magnetic base 1030 has a contact surface 1031 formed from a magnetic material. The contact surface 1031 is a lower surface of the magnetic base 1030, which comes into contact with and is magnetically attached to a magnetic workpiece. In the present embodiment, the contact surface 1031 is a flat surface orthogonal to the up-down direction of the magnetic drill press 1E. However, the contact surface 1031 may be a curved surface, or may have depressions and protrusions. The side surfaces and upper surface of the magnetic base 1030 are formed from a non-magnetic material. As will be described in detail later, the magnetic base 1030 is configured such that a magnetic attraction force acting on the workpiece due to the action of the magnetic force of the permanent magnets 1032 and 1033 can be switched between (i) a maximum state in which the magnetic attraction force is at the maximum, and (ii) a minimum state in which the magnetic attraction force is at the minimum. In the maximum state, the contact surface 1031 is firmly magnetically attached (latched) to the workpiece, and thus a positional relationship of the magnetic base 1030 (and thus, the magnetic drill press 1E) with the workpiece is reliably fixed. In the minimum state, typically, the magnetic attraction force is zero, and the contact surface 1031 is not magnetically attached to the workpiece. However, in the minimum state, the magnetic attraction force may act to such an extent that the relative positions of the contact surface 1031 and the workpiece can be changed.

The main housing 1020 is positioned above the magnetic base 1030, and is coupled to the magnetic base 1030. A loop handle 1080 that protrudes upward is disposed on an upper end surface of the main housing 1020. The user can grip the loop handle 1080 and can carry the magnetic drill press 1E. The loop handle 1080 is disposed at a position corresponding to the center of gravity, or in the vicinity thereof, of the magnetic drill press 1E in a plane extending orthogonally to the up-down direction. The main housing 1020 includes a battery attachment portion for detachably mounting a battery 1025 that supplies power to the magnetic drill press 1E. In place of the battery 1025, an AC commercial power supply may be used.

The drill unit 1040 is supported by the main housing 1020, so as to be movable relative to the main housing 1020 in the up-down direction (in other words, in the extending direction of the rotation axis AX1). Specifically, a guide rail 1021 that extends in the up-down direction is provided at a rear side edge portion of the drill unit 1040. Further, a guide rail 1042 that extends in the up-down direction is attached to a front side edge portion of the main housing 1020. The guide rail 1021 is disposed inside the guide rail 1042 and engages with the guide rail 1042 so as to be slidable in the up-down direction. As a result, the drill unit 1040 is configured to be movable in the up-down direction relative to the main housing 1020.

The magnetic drill press 1E further includes a rotation operation member 1070. The rotation operation member 1070 is coupled to a front portion of the main housing 1020. The rotation operation member 1070 is supported by the main housing 1020 so as to be rotatable, by manual operation, around a rotation axis extending in the left-right direction. Although not shown in detail, a shaft is disposed co-axially with the rotation axis of the rotation operation member 1070 inside the main housing 1020. A pinion formed on the peripheral surface of this shaft is meshed with a rack formed along the up-down direction in the guide rail 1021, via an opening in the guide rail 1042. According to this type of configuration, by rotating the rotation operation member 1070, the user can raise and lower the drill unit 1040 relative to the main housing 1020 by a distance, in the up-down direction, corresponding to a rotation amount of the rotation operation member 1070. The rotation operation member 1070 may be configured to be detachable from the main housing 1020. In such a case, the rotation operation member 1070 may be configured to be selectively attachable at a plurality of locations (typically, the left side surface and the right side surface of the main housing 1020).

A first operation member 1050 configured to be manually operated to change the magnetic attraction force of the magnetic base 1030 between the maximum state and the minimum state is mounted to a rear end surface of the main housing 1020. The first operation member 1050 protrudes from the rear end surface of the main housing 1020. In the present embodiment, the first operation member 1050 has the shape of a knob configured to be rotatable around a rotation axis extending in the front-rear direction.

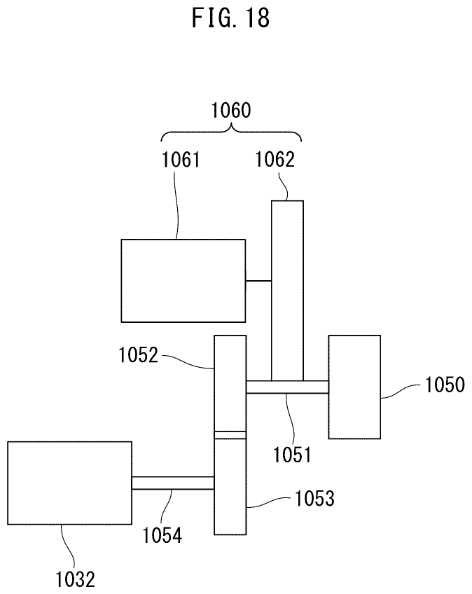

As shown in FIG. 18, a rod 1051 is coupled to the first operation member 1050, co-axially with the rotation shaft of the first operation member 1050. The rod 1051 penetrates the rear end wall of the main housing 1020 from the first operation member 1050, and extends into the inside of the main housing 1020. A gear 1052 is coupled to the rod 1051, inside the main housing 1020. The gear 1052 is meshed with a gear 1053 disposed below the gear 1052. One end of a rod 1054 is coupled to the gear 1053. The gear 1053 and the rod 1054 are accommodated inside the magnetic base 1030. The other end of the rod 1054 is coupled to the permanent magnet 1032. Owing to this configuration, the permanent magnet 1032 is configured to be rotated along with the first operation member 1050 when the first operation member 1050 is manually rotated. In another embodiment, the first operation member 1050 may be directly coupled to the permanent magnet 1032 in an operable manner (without being coupled via the gears 1052 and 1053, and the like).

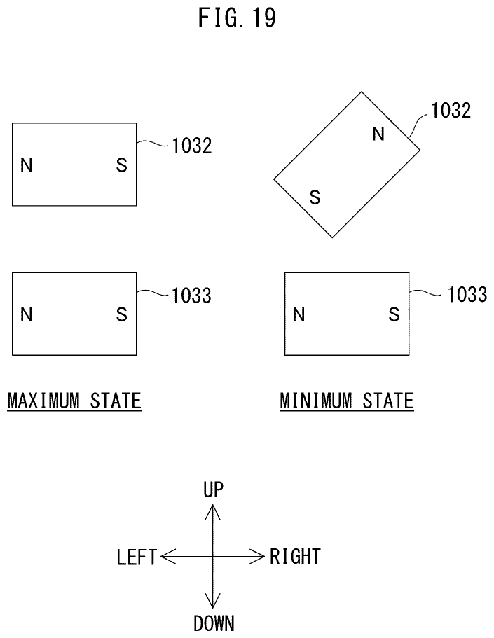

As shown in FIG. 19, the permanent magnets 1032 and 1033 are spaced away from each other in the up-down direction inside the magnetic base 1030 so as to face each other. As described above, the permanent magnet 1032 is rotatable in conjunction with the rotation of the first operation member 1050. On the other hand, the permanent magnet 1033 is fixed so as not to be displaceable. As shown on the left side in FIG. 19, when the permanent magnet 1032 is at a first position, in which the N pole of the permanent magnet 1032 is positioned on the same side as the N pole of the permanent magnet 1033 and the S pole of the permanent magnet 1032 is positioned on the same side as the S pole of the permanent magnet 1033, magnetic lines of flux pass through the workpiece that is in contact with the contact surface 1031, and thus, the maximum state is realized in which the magnetic attraction force is at the maximum. On the other hand, as shown on the right side in FIG. 19, when the permanent magnet 1032 is at a second position, in which the N pole of the permanent magnet 1032 is diagonally offset from the N pole of the permanent magnet 1033 and the S pole of the permanent magnet 1032 is diagonally offset from the S pole of the permanent magnet 1033, the magnetic lines of flux barely pass through the workpiece, and the minimum state is realized in which the magnetic attraction force is at the minimum.

This type of configuration for changing the magnetic attraction force is also disclosed, for example, in U.S. Pat. No. 9,452,521B2, which is hereby incorporated by reference in the present application in its entirety.

The manner of changing the magnetic attraction force on the workpiece by the action of the magnetic force of the permanent magnet is not limited to that described above, and the magnetic attraction force can be changed in any other desired manner. For example, in an alternative embodiment, as with a known magnetic chuck (magnetic latch) technique, a yoke disposed between a magnet and a workpiece in the up-down direction may be slid in parallel with the magnet to change a path of the magnetic lines of flux between (i) a first path passing through the workpiece without passing through the yoke, and (ii) a second path passing through the yoke and barely passing through the workpiece.

When using the magnetic drill press 1E described above, the user first performs the positioning of the magnetic drill press 1E with respect to the workpiece, while the contact surface 1031 is in contact with the workpiece. Next, the user manually rotates (turns) the first operation member 1050, and changes the magnetic attraction force of the magnetic base 1030 from the minimum state to the maximum state. In this way, the magnetic base 1030 is firmly magnetically attached to the workpiece. Next, the user manipulates the operation member of the drill unit 1040, and activates the motor, thus causes the drill 1041 to rotate. Next, the user manually rotates the rotation operation member 1070 to lower the drill 1041, and the drilling operation is performed while the bit 1045 rotating together with the drill 1041 is lowered toward the workpiece.

When the magnetic drill press 1E is used in the horizontally oriented posture (i.e., the posture in which the main housing 1020 and the magnetic base 1030 are aligned in the horizontal direction), or in the upwardly oriented posture (i.e., the posture in which the magnetic base 1030 is positioned above the main housing 1020 in the vertical direction), the operation to cause the magnetic attraction force to be the maximum state is not easy for the user. This is because the user usually needs to rotate the first operation member 1050 while supporting the magnetic drill press 1E with both hands. Thus, in the present embodiment, the magnetic drill press 1E is configured to facilitate the user's operation to cause the magnetic attraction force to be the maximum state even when the magnetic drill press 1E is used in the horizontally oriented posture or in the upwardly oriented posture. This type of configuration will be described below. Note that, in the present application, the “vertical direction” and the “horizontal direction” refer to directions that are not dependent on the posture of the magnetic drill press 1E. Specifically, the “vertical direction” refer to the direction in which gravity acts and the opposite direction thereto, and the “horizontal direction” means the direction orthogonal to the vertical direction.

As shown in FIG. 16 and FIG. 17, the magnetic drill press 1E further includes a second operation member 1055 and a drive device 1060. The second operation member 1055 is configured to be manually operated by a single touch to displace the permanent magnet 1032 toward the first position (toward the position for the maximum state). Note that a manual operation with a single touch may also be hereinafter referred to as a one-touch operation. In the present embodiment, the second operation member 1055 takes the form of a push button. However, as long as the one-touch operation is possible, the form of the second operation member 1055 can be changed as desired. For example, the second operation member 1055 make take the form of a sliding switch. According to this type of configuration, the user can easily manipulate the second operation member 1055 using a finger of one of the hands, while supporting the magnetic drill press 1E with both hands.

The second operation member 1055 can be disposed at any desired location. In the present embodiment, the second operation member 1055 is disposed on the same side surface as the rotation operation member 1070 is disposed. Furthermore, in the present embodiment, in the front-rear direction (in other words, in the direction in which the main housing 1020 and the drill unit 1040 are aligned), the second operation member 1055 is disposed at an end portion of the main housing 1020 that is on the opposite side from the drill unit 1040 (namely, on the rear end portion). More specifically, in the present embodiment, the second operation member 1055 is disposed in the vicinity of a rear edge portion of the left side surface of the main housing 1020, in the front-rear direction. When positioning the magnetic drill press 1E at a desired place with respect to the workpiece, the user normally supports the magnetic drill press 1E while gripping the loop handle 1080 with one hand and holding the vicinity of the rear end portion of the magnetic drill press 1E with the other hand. Therefore, the operation of the second operation member 1055 becomes even easier as a result of the second operation member 1055 being disposed in the vicinity of the rear end portion of the magnetic drill press 1E. In an embodiment in which an attachment position of the rotation operation member 1070 can be changed, a plurality of the second operation members 1055 may be disposed corresponding to each of the plurality of attachment positions of the rotation operation member 1070. Alternatively, taking into account the fact that the magnetic drill press 1E can be used in various postures, the plurality of second operation members 1055 may be disposed corresponding to the expected postures of the magnetic drill press 1E.

The drive device 1060 is provided for realizing the function of the second operation member 1055. Specifically, the drive device 1060 is configured to displace the permanent magnet 1032 to the first position (the position for the maximum state), in response to the operation of the second operation member 1055, and to also displace the first operation member 1050 toward the position corresponding to the maximum state. More specifically, as shown in FIG. 17 and FIG. 18, the drive device 1060 includes an electric motor 1061 and a gear 1062. The electric motor 1061 is accommodated inside the main housing 1020. The gear 1062 is disposed on the outside of the main housing 1020 in the present embodiment, but may be accommodated inside the main housing 1020. The gear 1062 is meshed with a pinion formed on the rod 1051 for transmitting the displacement of the first operation member 1050 to the permanent magnet 1032.

When the user manually presses the second operation member 1055, the electric motor 1061 is driven, the gear 1062 is rotated by a rotational driving force of the electric motor 1061, and the rod 1051 and thus the permanent magnet 1032 are also rotated. The electric motor 1061 is driven to rotate only to the direction that causes the permanent magnet 1032 to be displaced toward the first position. Further, owing to the rotation of the rod 1051, the first operation member 1050 is also rotated toward the position corresponding to the maximum state.

According to the above-described configuration, even when the magnetic drill press 1E is used in the horizontally oriented posture or the upwardly oriented posture, the user can cause the magnetic base 1030 to be magnetically attached to the workpiece by performing the one-touch operation of the second operation member 1055 using the hand supporting the magnetic drill press 1E to displace the permanent magnet 1032, without performing the rotational operation of the first operation member 1050. Thus, the user convenience is improved.

Furthermore, since the electric motor 1061 is used as the drive device 1060, it is possible to cause the second operation member 1055, the permanent magnet 1032, and the first operation member 1050 to operate in an interlocking manner using a simple device configuration. Note, however, that this type of interlocking operation may be realized by using any desired actuator or mechanical mechanism.

### Sixth Embodiment

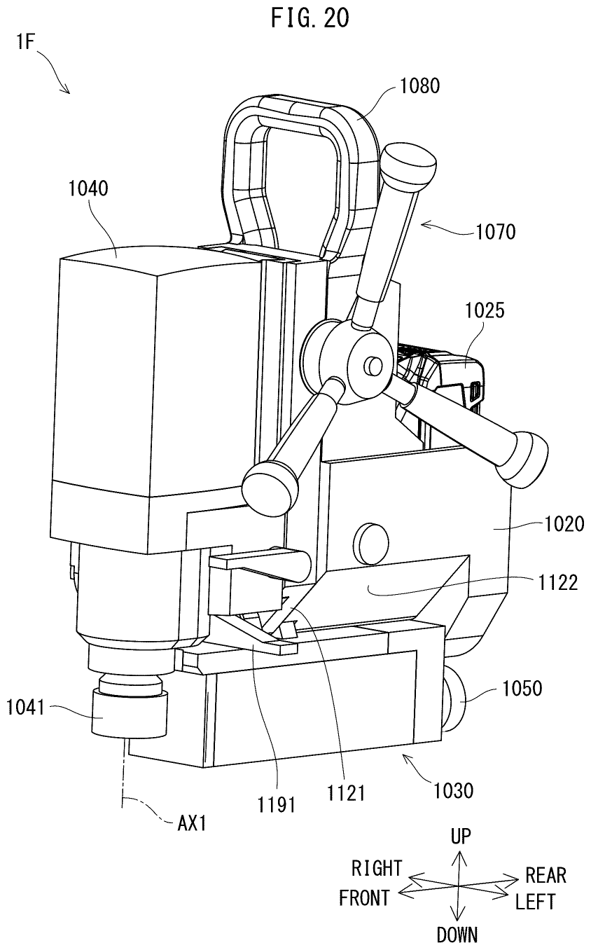

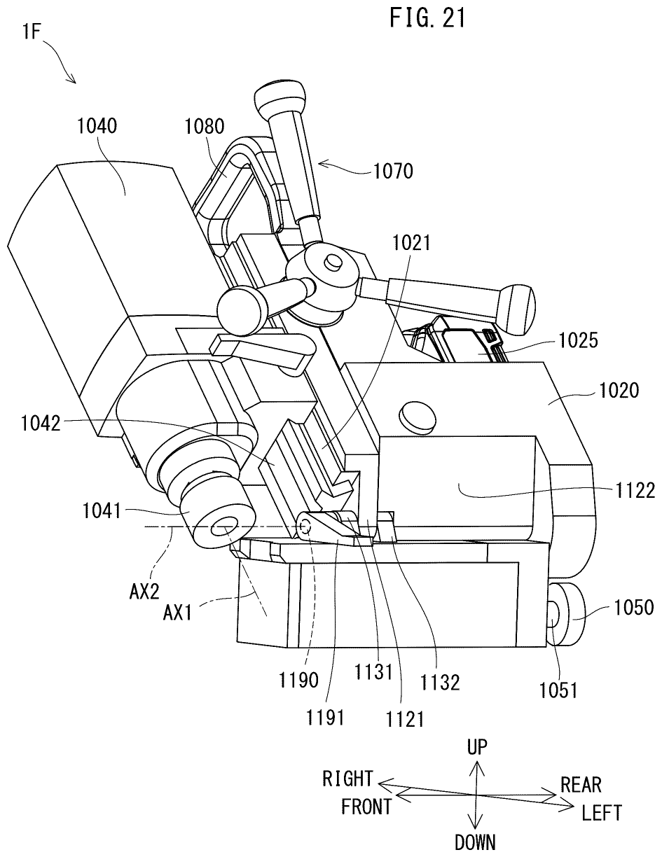

Hereinafter, a magnetic drill press 1F according to a sixth exemplary embodiment will be described with reference to FIG. 20 and FIG. 21. In the following description, only the points in which the magnetic drill press 1F differs from the fifth embodiment will be described. Note that the magnetic drill press 1F doe not include the second operation member 1055 and the drive device 1060 according to the fifth embodiment. Further, in this embodiment, the first operation member 1050 is provided at the magnetic base 1030, and the magnetic attraction force of the magnetic base 1030 is changed when the permanent magnet 1032, which is directly coupled to the rod 1051, is rotated.

In the sixth embodiment, the main housing 1020 and the drill unit 1040 are configured to be tiltable relative to the magnetic base 1030 about a tilting axis AX2 extending in the front-rear direction. Specifically, as shown in FIG. 21, the magnetic base 1030 is provided with support portions 1131 and 1132 at the top portion on the front side thereof. The support portions 1131 and 1132 are spaced apart from each other in the front-rear direction. A coupling portion 1121 formed at a front edge of the main housing 1020 is between the support portion 1131 and the support portion 1132. Through holes, which are co-axial and penetrate in the front-rear direction, are formed in each of the support portions 1131 and 1132, and the coupling portion 1121 of the main housing 1020.

A bolt 1190 is inserted through these through holes, and a nut (not shown in the drawings) is engaged with a tip end (a rear end) of the bolt 1190. The head of the bolt 1190 is rotationally fixed inside an operation lever 1191. When the user manually rotate (turn) the operation lever 1191 to tighten the bolt 1190, the coupling portion 1121 is clamped in the front-rear direction by the support portions 1131 and 1132 and the relative positions of the coupling portion 1121 and the support portions 1131 and 1132 (and thus the relative positions of the main housing 1020 and the magnetic base 1030) are fixed.

On the other hand, when the user manually rotate the operation lever 1191 in the opposite direction to loosen the bolt 1190, the fixed correlation of the relative positions of the main housing 1020 and the magnetic base 1030 is released. In this state, the user can tilt the main housing 1020 and the drill unit 1040 about the tilting axis AX2 (the bolt 1190) relative to the magnetic base 1030 to place the main housing 1020 and the drill unit 1040 at a desired tilted position. When the bolt 1190 is tightened with the main housing 1020 and the drill unit 1040 at the desired tilted position, the relative positions of the main housing 1020 and the magnetic base 1030 are fixed at that tilted position. In this type of titling operation, in order to avoid interference between the main housing 1020 and the magnetic base 1030, recessed portions 1122 are formed in each of the right side surface and the left side surface of the main housing 1020 (only the recessed portion 1122 on the left side surface is visible in FIG. 21).

According to the above-described magnetic drill press 1F, it is possible to selectively perform the drilling operation in (i) a standing posture in which the rotation axis AX1 of the drill 1041 extends in the up-down direction of the magnetic drill press 1F (refer to FIG. 20), and (ii) a tilted posture in which the rotation axis AX1 is tilted with respect to the up-down direction of the magnetic drill press 1F (refer to FIG. 21). According to the latter posture, it is possible to form a hole extending in a direction that is angled with respect to the direction in which the workpiece and the magnetic drill press 1F are aligned.

### Seventh Embodiment

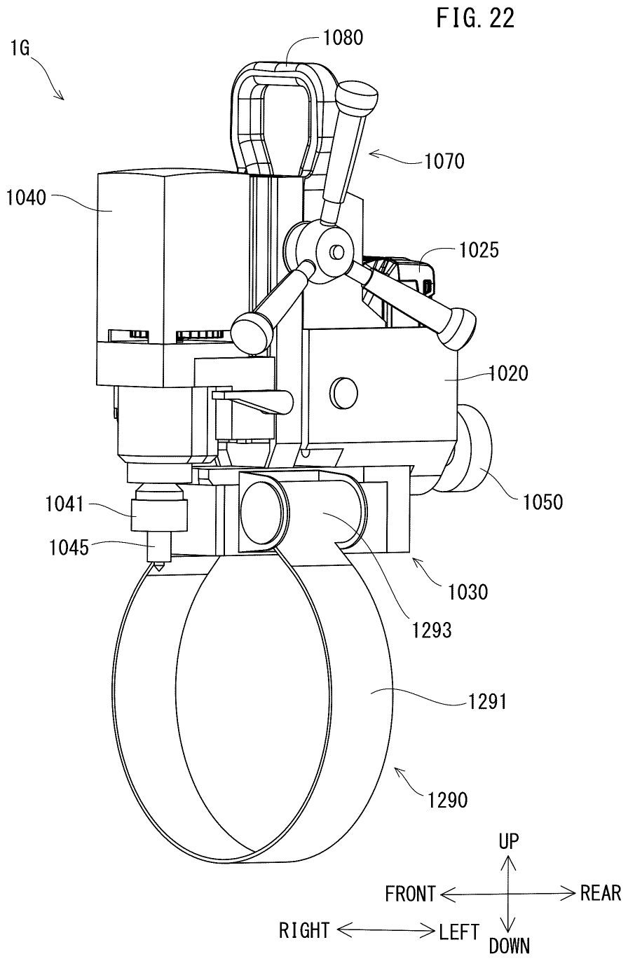

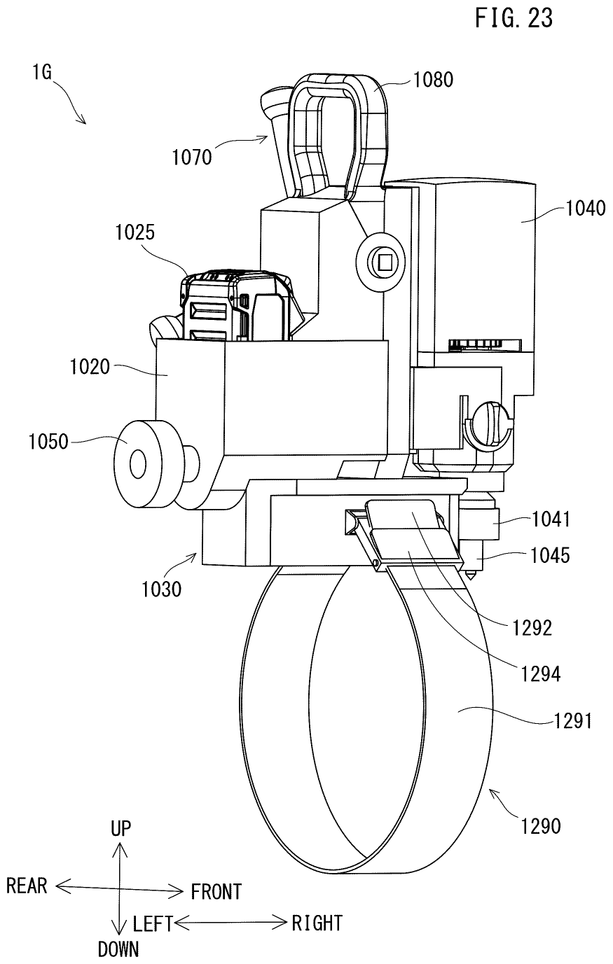

Hereinafter, a magnetic drill press 1G according to a seventh exemplary embodiment will be described with reference to FIG. 22 and FIG. 23. In the following description, only the points in which the magnetic drill press 1G differs from the fifth embodiment will be described. The magnetic drill press 1G does not include the second operation member 1055 and the drive device 1060 according to the fifth embodiment.

As shown in FIG. 22 and FIG. 23, the magnetic drill press 1G includes a fall prevention belt 1290. When using the magnetic drill press 1G, a portion (section) of the fall prevention belt 1290 is disposed to form a ring shape that surrounds a workpiece (a steel beam, for example) extending in space, and is then tightened around the workpiece. In this way, it is possible to fix the magnetic drill press 1G so as not to fall. The fall prevention belt 1290 is an automatic-winding type belt. Specifically, the fall prevention belt 1290 includes a long belt body 1291, a winding portion 1293, and a fixing portion 1294.

In the present embodiment, the fall prevention belt 1290 is fixed to the magnetic base 1030 so as not to be detachable. Owing to such a configuration, the user does not need to mount the fall prevention belt 1290 to the magnetic base 1030 before using the magnetic drill press 1G. Note, however, that the fall prevention belt 1290 may be detachably attached to the magnetic base 1030. Further, by attaching the fall prevention belt 1290 to the magnetic base 1030, compared to a configuration in which the fall prevention belt 1290 is attached to the main housing 1020, a length of the portion of the fall prevention belt 1290 that needs to be extended to surround the workpiece becomes shorter. Thus, a gap is less likely to occur between the fall prevention belt 1290 and the workpiece. It is thus possible to reduce loosening of the fall prevention belt 1290 with respect to the workpiece. Note, however, that the fall prevention belt 1290 may be attached to the main housing 1020, instead of the magnetic base 1030.

An automatic winding device is built into the winding portion 1293. As the automatic winding device, for example, a winding device used for a vehicle seatbelt, or a winding device for a cord of a vacuum cleaner are widely known. The winding portion 1293 may include an operation member to be manipulated for winding, as in the winding device of the vacuum cleaner cord. The winding portion 1293 is fixed to a left side surface of the magnetic base 1030. The fixing portion 1294 is configured to fix (secure) a tip end 1292 of the belt body 1291. Any desired known structure that is able to fix the tip end 1292 using a one-touch operation can be used as the fixing portion 1294.

According to the magnetic drill press 1G, the length of the portion of the fall prevention belt 1290 surrounding the workpiece automatically contracts so as to eliminate looseness around the workpiece (including a case in which it contracts without any manual operation, and a case in which it contracts in response to a one-touch operation). Thus, the user need not perform a separate operation to tighten the belt body 1291 around the workpiece. Furthermore, the user can secure the fall prevention belt 1290 to the workpiece by the one-touch operation using the hand supporting the magnetic drill press 1G.

### Eighth Embodiment

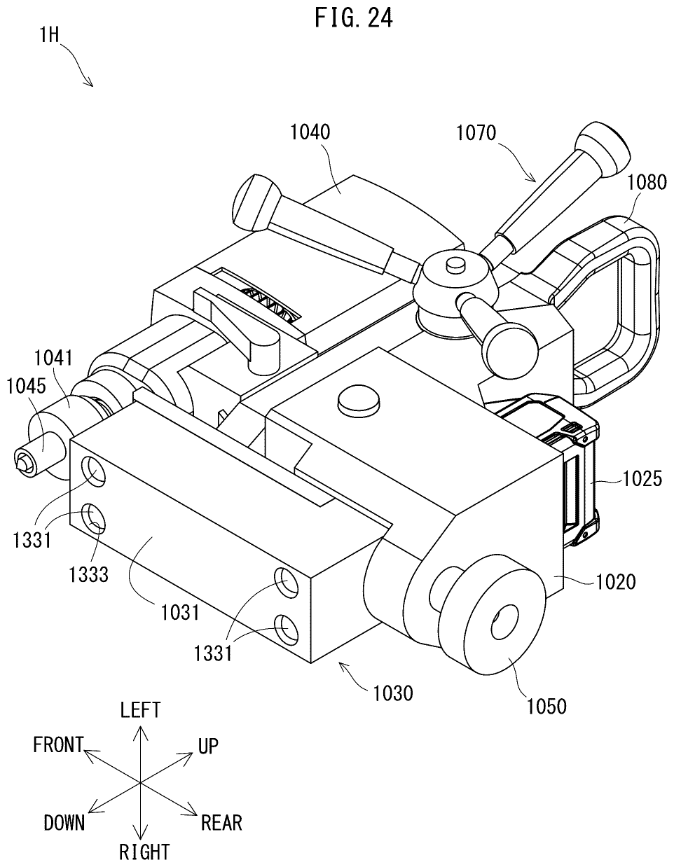

Hereinafter, a magnetic drill press 1H according to an eighth exemplary embodiment will be described with reference to FIG. 24 to FIG. 28. In the following description, only the points in which the magnetic drill press 1H differs from the fifth embodiment will be described. The magnetic drill press 1H does not include the second operation member 1055 and the drive device 1060 according to the fifth embodiment.

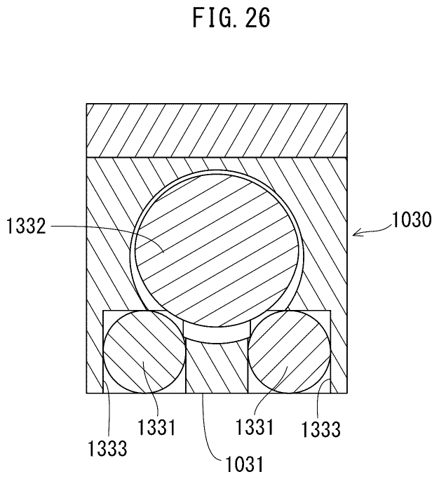

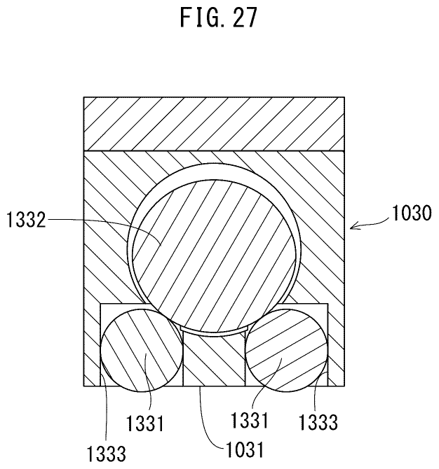

As shown in FIG. 24, the magnetic base 1030 of the magnetic drill press 1H includes four protruding members 1331. Each of the protruding members 1331 is accommodated, so as not to fall out, inside a bottomed hole 1333 formed in a bottom portion of the magnetic base 1030. As seen from below, the four protruding members 1331 are disposed in the vicinity of the four corners of the substantially rectangular magnetic base 1030 (of the contact surface 1031). The protruding members 1331 can be mechanically displaced in response to a manual operation, without receiving any magnetic action, between (i) a retracted position at which the protruding members 1331 are closest to the main housing 1020 (refer to FIG. 26), and (ii) a protruding position at which the protruding members 1331 are farthest from the main housing 1020 (refer to FIG. 27). In the present embodiment, the protruding members 1331 are formed from a magnetic material, but may be formed from a non-magnetic material.

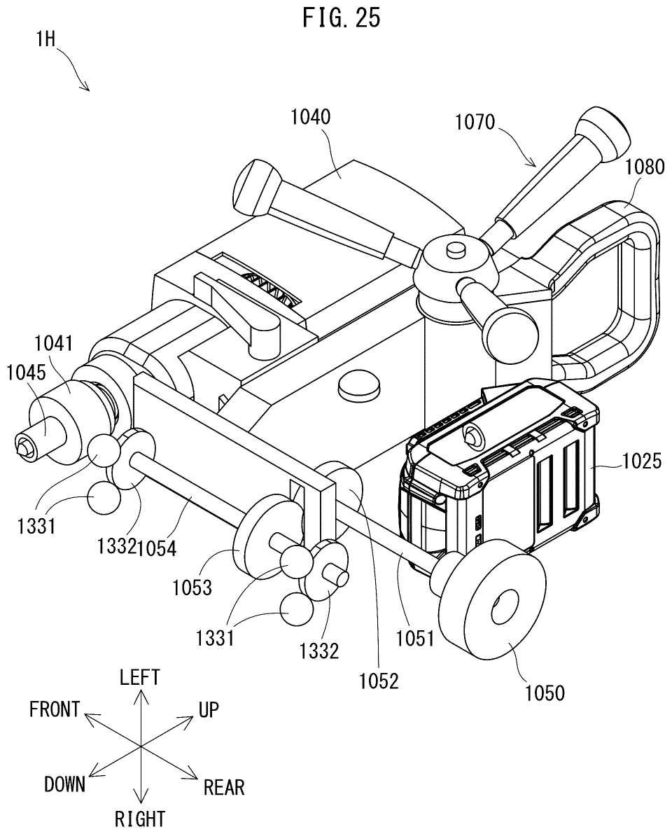

In the present embodiment, displacement of the protruding members 1331 is interlocked with the displacement of the first operation member 1050. Specifically, as shown in FIG. 25 (in FIG. 25, in order to enhance visibility, the main housing 1020, the magnetic base 1030, and the permanent magnets 1032 and 1033 are omitted), both ends of the rod 1054 that rotatably supports the permanent magnet 1032 (not shown in FIG. 25) are coupled to cams 1332. When the rod 1054 rotates in accordance with the rotational operation of the first operation member 1050, the cams 1332 also rotate together with the rod 1054. When the first operation member 1050 is at the position corresponding to the maximum state in which the magnetic attraction force is at the maximum, as shown in FIG. 26, the cam 1332 is at a rotation angle position at which the cam 1332 is not in contact with the protruding members 1331. As a result, the protruding members 1331 are at a position that does not extend downward of the contact surface (bottom surface) 1031 of the magnetic base 1030 (namely, are at the retracted position). On the other hand, when the first operation member 1050 is at the position corresponding to the minimum state, in which the magnetic attraction force is at the minimum, as shown in FIG. 27, the cam 1332 is at a position at witch the cam 1332 presses the protruding members 1331 downward. As a result, the protruding members 1331 protrude slightly downward of the contact surface 1031 of the magnetic base 1030 (namely, are at the protruding position).

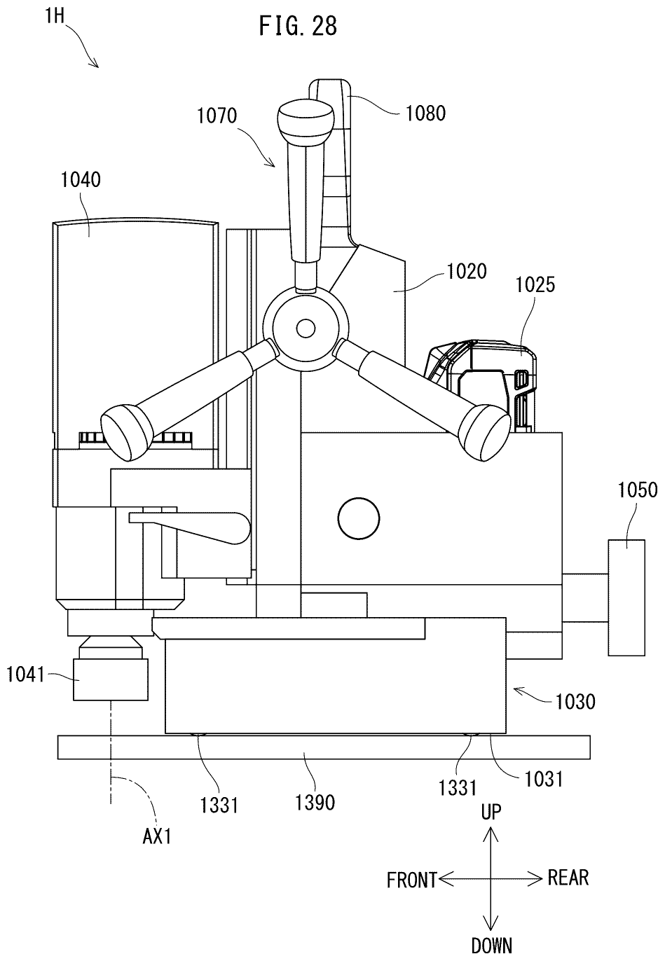

When the protruding members 1331 are at the retracted position (when the magnetic attraction force is in the maximum state), the contact surface 1031 can be in contact with the workpiece. As a result, the magnetic base 1030 (and thus the magnetic drill press 1H) can be firmly fixed to the workpiece. On the other hand, when the protruding members 1331 are at the protruding position (when the magnetic attraction force is in the minimum state), even when the magnetic base 1030 is placed on the workpiece, the contact surface 1031 does not come into contact with the workpiece. As a result, as shown in FIG. 28, only bottom portions of the protruding members 1331 are in contact with the workpiece.

In other words, when the magnetic attraction force is in the minimum state, compared to when the magnetic attraction force is in the maximum state, the magnetic attraction force with respect to the workpiece is significantly weaker (or is zero), since there is a gap between the contact surface 1031 and the workpiece. Further, the contact area is slight between the workpiece and the protruding members 1331 formed from the magnetic material and having the easily rollable spherical shape. Thus, even when the magnetic attraction force acts on the workpiece, the user can perform alignment between a position at which a hole is to be drilled in the workpiece and the center of the drill 1041 (i.e., the center of the bit 1045 attached to the drill 1041, which coincides with the rotation axis AX1) (hereinafter also referred to as alignment of the processing position) by sliding the magnetic drill press 1H with a smaller force. Thus, the user can easily perform the alignment of the processing position. If the magnetic attraction force with respect to the workpiece in the minimum state is zero, or when the protruding members 1331 are formed from the non-magnetic material, the magnetic attraction force does not act between the protruding members 1331 and the workpiece, and the alignment of the processing position becomes even easier.

Furthermore, in the present embodiment, the first operation member 1050 and the protruding members 1331 are interlocked via the rod 1051, the gears 1052 and 1053, the rod 1054, and the cams 1332, such that the contact area between the workpiece and the magnetic base 1030 is (i) relatively large when the first operation member 1050 is at the position corresponding to the maximum state, and (ii) relatively small when the first operation member 1050 is at the position corresponding to the minimum state. Thus, the user need not separately perform the manual operation for displacing the protruding members 1331 and the manual operation of the first operation member 1050. Note that the magnetic drill press 1H may be configured such that the displacement of the first operation member 1050 and the displacement of the protruding members 1331 are not interlocked. In this case, the magnetic drill press 1H may include a manual operation member for displacing the protruding members 1331 that is discrete from the first operation member 1050.

In an alternative embodiment, the number of the protruding members 1331 is not particularly limited, and can be a desired number of one or more. Furthermore, in an alternative embodiment, the protruding member 1331 need not necessarily be the spherical shape, and may have any desired shape (a cylindrical shape, for example). Even in such an embodiment, as long as the protruding member(s) 1331 is (are) formed of the non-magnetic material, the user can easily perform the alignment of the processing position since the magnetic attraction force does not act between the protruding member(s) 1331 and the workpiece.

Furthermore, in a further alternative embodiment, the magnetic drill press 1H may be configured such that the position of the protruding members 1331 can be selectively switched between the protruding position and the retracted position when the magnetic attraction force is in the maximum state. In such an embodiment, the magnetic drill press 1H may include a manual operation member for displacing the protruding members 1331 that is discrete from the first operation member 1050. Even with this configuration, the user can easily perform the alignment of the processing position in the state in which the protruding members 1331 are at the protruding position (in other words, in the state in which the contact area between the workpiece and the magnetic base 1030 is relatively small).

Furthermore, in an alternative embodiment, the magnetic base 1030 may be configured such that the magnetic attraction force acting on the workpiece is relatively large when the protruding members 1331 are at the protruding position, and the magnetic attraction force acting on the workpiece is relatively small when the protruding members 1331 are at the retracted position. For example, recesses and protrusions may be formed at the bottom surface of the magnetic base 1030. Further, the protruding members 1331 may be accommodated in the recesses. In such an embodiment, when the protruding members 1331 are at the protruding position, the relatively large contact area may be achieved by the protruding members 1331 protruding to the same level as the protrusions such that the protruding members 1331 can be made in contact with the workpiece, and when the protruding members 1331 are at the retracted position, the relatively small contact area may be achieved by the protruding members 1331 being retracted toward the main housing 1020 more than the protrusions at the bottom surface of the magnetic base 1030 such that the protruding members 1331 can not contact the workpiece.

### Ninth Embodiment

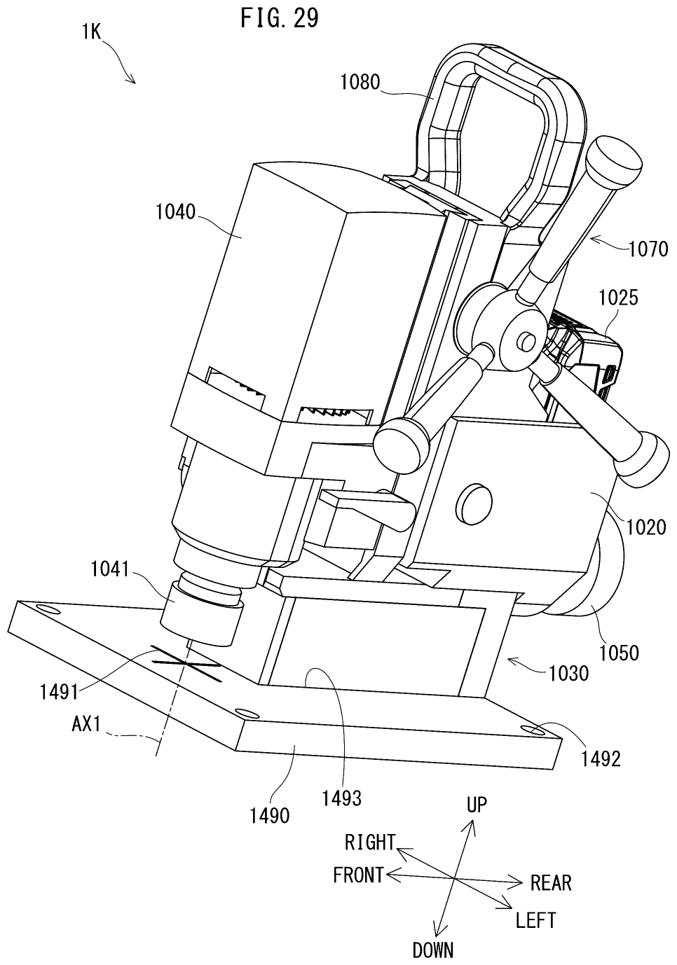

Hereinafter, a magnetic drill press 1K according to a ninth exemplary embodiment will be described with reference to FIG. 29. In the following description, only the points in which the magnetic drill press 1K differs from the fifth embodiment will be described. The magnetic drill press 1K does not include the second operation member 1055 and the drive device 1060 according to the fifth embodiment.

As shown in FIG. 29, the magnetic drill press 1K includes a plate attachment 1490. The magnetic drill press 1K can be used for drilling a hole in a relatively small workpiece. The plate attachment 1490 is substantially plate shaped, and is formed from a magnetic material. As shown in FIG. 29, the magnetic drill press 1K is used in a state in which the plate attachment 1490 and the magnetic base 1030 are magnetically attached to each other. Since the plate attachment 1490 is formed from the magnetic material, the magnetic drill press 1K can be firmly fixed on the plate attachment 1490.

The plate attachment 1490 has a size such that the rotation axis AX1 of the drill 1041 intersects the plate attachment 1490 when the plate attachment 1490 is magnetically attached to the magnetic base 1030. Thus, as long as the workpiece is disposed directly below the drill 1041, a hole can be drilled in the workpiece on the magnetic drill press 1K. When the workpiece is formed from the magnetic material, since the plate attachment 1490 becomes magnetized owing to the magnetic force of the magnet of the magnetic base 1030, the drilling operation can be performed on the workpiece that is fixed to the plate attachment 1490 by the magnetic attraction force of the plate attachment 1490. When the workpiece is formed by the non-magnetic material, the user can perform the drilling operation by disposing the workpiece on the plate attachment 1490 magnetically attached to the magnetic base 1030, and holding the workpiece by hand. In this case, the plate attachment 1490 can also be utilized as the workbench.

As shown in FIG. 29, the plate attachment 1490 includes a positioning recess 1493 that at least partially conforms to the shape of the magnetic base 1030. In the present embodiment, the positioning recess 1493 has a shape conforming to an entirety of the magnetic base 1030. In place of this configuration, the positioning recess 1493 may be configured to have an area larger than the magnetic base 1030 such that only a front half of the positioning recess 1493 conforms to a front half of the magnetic base 1030, and a rear half of the positioning recess 1493 accommodates a rear half of the magnetic base 1030.

The plate attachment 1490 is further provided with marking 1491. In the present embodiment, the marking 1491 has a cross shape, but may have any desired shape. The marking 1491 is disposed such that the center of the cross is aligned with the rotation axis AX1 of the drill 1041 when the magnetic base 1030 is appropriately positioned inside the positioning recess 1493. According to this configuration, the positioning of the magnetic base 1030 with respect to the plate attachment 1490 can be easily performed.

In an alternative embodiment, the plate attachment 1490 may include a through hole such that the rotation axis AX1 (in other words, the bit 1045) can pass through the through hole when the plate attachment 1490 is magnetically attached to the magnetic base 1030. According to this configuration, even when forming a through hole in the workpiece using the magnetic drill press 1K, as long as the drilling operation is performed in a state in which the positions of the through hole to be formed in the workpiece and the through hole of the plate attachment 1490 are aligned, the plate attachment 1490 is not damaged. Thus, the useful life of the plate attachment 1490 can be extended. In this embodiment, the plate attachment 1490 may be configured such that the position of the through hole of the plate attachment 1490 is aligned with the rotation axis AX1, when the magnetic base 1030 is appropriately positioned inside the positioning recess 1493.

The plate attachment 1490 has a plurality of through holes 1492 (four in the illustrated example). The through holes 1492 are disposed at four corners of the substantially rectangular plate attachment 1490. The through holes 1492 can be used to fix the plate attachment 1490 to the workbench, using any desired fastener.

### Tenth Embodiment

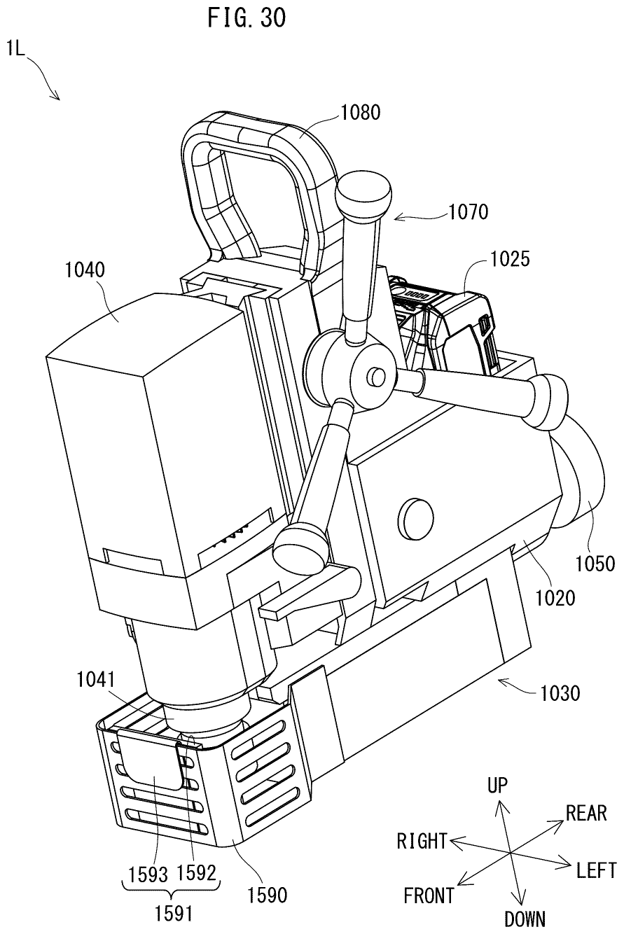

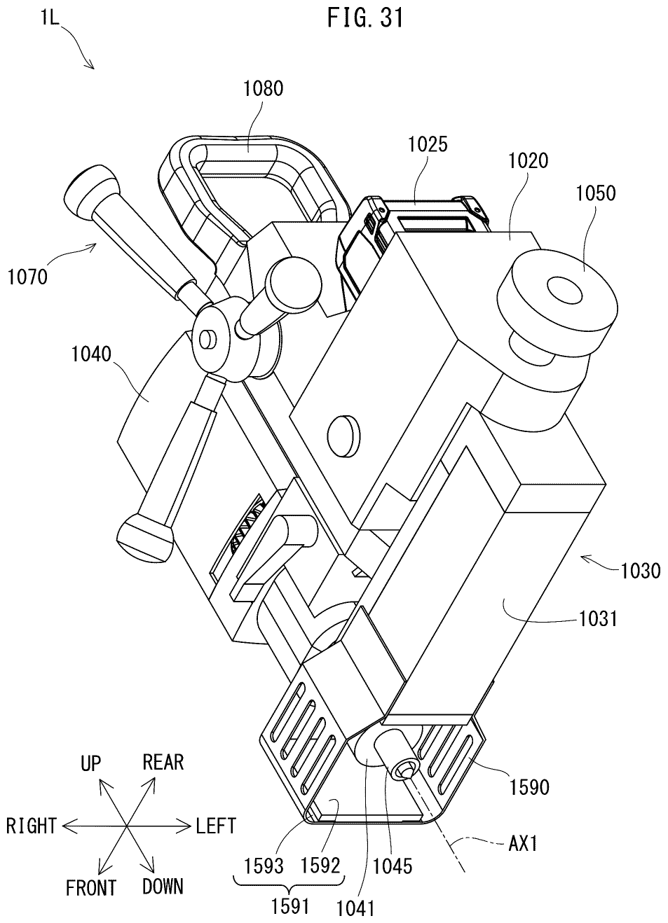

A magnetic drill press 1L according to a tenth exemplary embodiment will be described with reference to FIG. 30 and FIG. 31. In the following description, only the points in which the magnetic drill press 1L differs from the fifth embodiment will be described. The magnetic drill press 1L does not include the second operation member 1055 and the drive device 1060 according to the fifth embodiment.

As shown in FIG. 30 and FIG. 31, the magnetic drill press 1L includes a cover 1590 and a magnet attachment 1591. The cover 1590 is attached to the magnetic base 1030 so as to partially surround the periphery of the drill 1041 in a U-shape. Through holes are formed in the cover 1590, in order to enhance visibility of the processing position (the tip end of the bit 1045). The cover 1590 can suppress chips generated by the drilling operation from being dispersed to the surroundings.

The magnet attachment 1591 includes a permanent magnet 1592 and an engagement portion 1593. In the present embodiment, the permanent magnet 1592 takes the form of a magnet plate. The engagement portion 1593 has a form in which a plate is bent into a non-symmetrical U-shape, and includes two opposing flat plate portions. A surface area of one of the flat plate portions is larger than a surface area of the other of the flat plate portions. The permanent magnet 1592 is affixed to the larger flat plate portion of the engagement portion 1593 (more specifically, a surface on the opposite side from the smaller flat plate portion).

The magnet attachment 1591 is detachably attached, in a fixed manner (that is, in a non-displaceable manner), in the vicinity of the tip end of the drill 1041. Specifically, the magnet attachment 1591 is placed over an upper edge of a front wall of the cover 1590 such that the front wall of the cover 1590 is positioned between the two flat plate portions of the engagement portion 1593. In this way, the magnet attachment 1591 is detachably engaged with the cover 1590. At this time, the permanent magnet 1592 is at a position facing the drill 1041.

According to the magnetic drill press 1L, long spiral-shaped chips are separated from the bit 1045 and become magnetically attached to the magnet attachment 1591 during the drilling operation. When the spiral-shaped chips, which rotate together with the bit 1045, become magnetically attached to the fixed magnet attachment 1591, a shearing force acts on the chips, and the chips are cut partway along the length thereof. Thus, the magnet attachment 1591 can easily separate the chips from the bit 1045 and gather the chips. Thus, it is possible to suppress the deterioration in the visibility of the processing position caused by the chips. Further, by removing the magnet attachment 1591, to which the chips are magnetically attached, from the cover 1590, the user can easily eliminate the chips from the magnet attachment 1591. Furthermore, by utilizing the cover 1590, the magnet attachment 1591 can be disposed at an appropriate position spaced away from the tip end of the drill 1041.

In an alternative embodiment, a magnet attachment of a desired shape may be attached in a desired manner to a desired position in the vicinity of the tip end of the drill 1041. For example, a magnet holder may be provided that extends forward from a front edge portion of the magnetic base 1030 without interfering the drill 1041. In this embodiment, the permanent magnet may be attached to the magnet holder.

Various embodiments of the present invention are described above, but the above-described embodiments are intended to facilitate understanding of the present invention and are not intended to limit the present invention. Insofar as they do not depart from the gist and scope of the present invention, changes and improvements can be made, and equivalents of the embodiments are included in the present invention. Further, insofar as at least one of the above-described issues is solved, or at least one of the effects can be achieved, each of the structural elements listed in the claims and in the specification can be combined, or can be omitted as desired.

For example, in the sixth to tenth embodiments, electromagnets may be used in place of the permanent magnets 1032 and 1033. Further, insofar that at least some of the functions of the above-described magnetic drill press can be realized, desired mechanical mechanisms may be adopted in the alternative to the preceding configurations.

1. A magnetic drill press comprising:
a magnetic base configured to be selectively fixed to a workpiece by a magnetic force;
a main body portion coupled to the magnetic base;
a drill unit including a spindle configured to detachably hold a tool accessory, the drill unit being supported by the main body portion to be movable in a direction parallel to a rotation axis of the spindle;
a battery attachment portion configured to detachably hold a battery for supplying power to the magnetic drill press; and
a cover configured to at least partially cover the battery attachment portion,
wherein the battery attachment portion includes:
a rail extending in a straight line in a first direction and configured to slidingly engage with a groove of the battery, in response to the battery being moved, relative to the rail, from a first side to a second side in the first direction; and
a terminal portion including a terminal configured to be electrically connected with a terminal of the battery, in response to the battery being disposed at a predetermined position of the battery attachment portion, and
the cover is displaceable relative to the main body portion, and is configured to overlap an entirety of the terminal portion, when the cover is at a first position and viewed from the first side in the first direction.

2. The magnetic drill press according to claim 1, wherein the cover is configured to substantially cover an entirety of an exposed portion of the battery attached to the battery attachment portion that is exposed from the battery attachment portion when the cover is at the first position.

3. The magnetic drill press according to claim 1, wherein
the battery attachment portion includes a recess configured for at least a portion of the battery to be fitted therein,
the recess has an opening on the first side in the first direction, and
the cover is configured to substantially block the opening of the recess when the cover is at the first position.

4. The magnetic drill press according to claim 3, wherein the recess is configured to accommodate at least a half of the battery.

5. The magnetic drill press according to claim 1, further comprising:
a locking member configured to lock the cover at the first position relative to the main body portion.

6. The magnetic drill press according to claim 1, wherein
the cover is coupled to the main body portion to be pivotable between the first position and a second position, and
the cover is configured to allow attachment and removal of the battery when the cover is at the second position.

7. The magnetic drill press according to claim 1, wherein the first direction is the direction parallel to the rotation axis of the spindle.

8. The magnetic drill press according to claim 2, wherein:
the battery attachment portion includes a recess configured for at least a half of the battery to be fitted therein,
the recess has an opening on the first side in the first direction, and
the cover is configured to substantially block the opening of the recess when the cover is at the first position.

9. The magnetic drill press according to claim 8, wherein
the cover is coupled to the main body portion to be pivotable between the first position and a second position, and
the cover is configured to allow attachment and removal of the battery when the cover is at the second position.

10. The magnetic drill press according to claim 9, further comprising:
a locking member configured to lock the cover at the first position relative to the main body portion.

11. A magnetic drill press comprising:
a magnetic base configured to be selectively fixed to a workpiece by a magnetic force;
a battery housing portion coupled to an upper side of the magnetic base and having an opening in an upper portion thereof;
a guide portion coupled to the battery housing portion;
a guided portion guided in an up-down direction by the guide portion;
a motor coupled to the guided portion, and configured to be rotated by power supplied from the battery housing portion;
a drill unit including a spindle configured to be rotated by the motor; and
a cover configured to cover the opening of the battery housing portion.

12. The magnetic drill press according to claim 11, wherein the battery housing portion is a recess that is configured to accommodate at least a half of the battery.

13. The magnetic drill press according to claim 11, further comprising:
a locking member configured to lock the cover when the cover is at a first position at which the cover blocks the opening of the battery housing portion.

14. The magnetic drill press according to claim 11, wherein
the cover is pivotable between a first position at which the cover blocks the opening of the battery housing portion and a second position at which the cover opens the opening.

15. The magnetic drill press according to claim 11, wherein a rotation axis of the spindle extends in up-down direction.
